(19) United States
(12) Patent Application Publication
(10) Pub. No.: US 2020/0140743 A1
(43) Pub. Date: May 7, 2020

(54) Microparticles and Method for Modifying the Permeability of a Reservoir Zone

(71) Applicant: BP Exploration Operating Company Limited, Middlesex (GB)

(72) Inventors: Rachel Kelly O'Reilly, Coventry (GB); Rebecca Jane Williams, Coventry (GB)

(73) Assignee: BP Exploration Operating Company Limited, Middlesex (GB)

(21) Appl. No.: 16/605,816

(22) PCT Filed: Apr. 24, 2018
(86) PCT No.: PCT/EP2018/060458

§ 371 Date: Oct. 17, 2019

(30) Foreign Application Priority Data
Apr. 27, 2017 (EP) 17168536.5
Jun. 29, 2017 (GB) 1710416.7

(51) Int. Cl. C09K 8/588; E21B 43/16; C08F 230/02; C08F 220/38

(52) U.S. Cl. CPC C09K 8/588; E21B 43/162; C09K 2208/10; C08F 220/38; C08F 230/02

(57) ABSTRACT

A process for reducing the permeability to water of a thief zone of a porous and permeable subterranean petroleum reservoir by injecting a dispersion of polymeric microparticles in an aqueous fluid down a well and into the thief zone, wherein the polymeric microparticles comprise crosslinked copolymer chains having structural units derived from (i) a water-soluble or water-dispersible monomer with a betaine group, (ii) a water-insoluble monomer, and, (iii) a cross-linking monomer having at least two sites of ethylenic unsaturation, and the polymeric microparticles have a transition temperature above the maximum temperature encountered in the well and at or below the maximum temperature encountered in the thief zone and, and the polymeric microparticles expand in size in the thief zone when they encounter a temperature at or greater than the transition temperature so as to reduce the permeability of the thief zone to water.

### CROSS-REFERENCE TO RELATED APPLICATIONS

This application is a 35 U.S.C. § 371 national stage application of PCT/EP2018/060458 filed Apr. 24, 2018, entitled “Microparticles and Method for Modifying the Permeability of a Reservoir Zone,” which claims priority to EP Application No. 17 16 8536.5 filed Apr. 27, 2017 and GB 1710416.7 filed 29 Jun. 2017, the disclosures of each of which are hereby incorporated herein by reference for purposes not contrary to this disclosure.

### STATEMENT REGARDING FEDERALLY SPONSORED RESEARCH OR DEVELOPMENT

None.

### TECHNICAL FIELD

The present disclosure relates to a method of modifying the permeability of a thief zone of a subterranean petroleum reservoir to water; more particularly, this disclosure relates to a composition for use in a method of modifying the permeability to water of a thief zone of a subterranean petroleum reservoir, the composition comprising a dispersion of temperature sensitive microparticles in water, wherein the microparticles expand in size at above a threshold temperature.

### BACKGROUND

Processes for modifying the permeability to water of subterranean petroleum reservoirs are particularly useful in the field of recovery of hydrocarbon fluids, for example, crude oil from a petroleum reservoir. Crude oil may be recovered from a petroleum reservoir via natural pressure in the reservoir forcing hydrocarbon fluids towards production wells where they can flow or are pumped to a surface production facility (referred to as “primary recovery”). However, reservoir pressure is generally sufficient only to recover around 10 to 20 percent of the total hydrocarbon present in a subterranean petroleum reservoir. Accordingly “secondary recovery” techniques are applied to recover hydrocarbon from subterranean reservoirs in which the hydrocarbon fluids no longer flow by natural forces.

Secondary recovery relies on the supply of external energy to maintain the pressure in a subterranean petroleum reservoir and to sweep hydrocarbon fluids towards a production well. One such technique involves the injection of water (such as aquifer water, river water, estuarine water, seawater, or a produced water) into the petroleum reservoir via one or more injection wells to drive the hydrocarbon fluids towards one or more production wells. The injection of water during secondary recovery is commonly referred to as water flooding.

Enhanced Oil Recovery (EOR) processes involve injecting an aqueous fluid into a petroleum reservoir that is formulated to increase recovery of hydrocarbon fluids over that which would be achieved by water injection alone. The processes employed during EOR can be initiated at any time during the productive life of a petroleum reservoir. If an EOR process is employed in secondary recovery, the aqueous fluid supplies the external energy to maintain the pressure of the reservoir as well as increasing recovery of hydrocarbon fluids over that which would be achieved by water injection alone. If an EOR process is employed in tertiary recovery, injection of the original aqueous fluid used in secondary recovery is stopped and a different aqueous fluid is injected into the petroleum reservoir that is formulated to increase recovery of hydrocarbon fluids over that which would be achieved with the original water alone. Thus, the purpose of EOR is not only to restore reservoir pressure and to sweep oil towards a production well, but also to improve oil displacement or fluid flow in the reservoir.

The efficiency of water flooding techniques depends on a number of variables, including the permeability of the reservoir rock and the viscosity of the hydrocarbon fluids in the reservoir. A prevalent problem with secondary and tertiary recovery projects relates to the heterogeneity of the reservoir rock strata. Natural variations in the permeability of different zones (layers or areas) of a subterranean petroleum reservoir means that the injected aqueous fluid tends to travel most easily in, and therefore preferentially sweeps, the highest permeability zones (i.e., the injected aqueous fluid follows the lowest resistance path from the injection well to the production well), thereby potentially by-passing much of the hydrocarbon fluid present in lower permeability zones of the reservoir. Once the highest permeability zones are thoroughly swept they tend to accept most of the injected aqueous fluid and act as “thief zones”. In such cases the injected aqueous fluid does not effectively sweep the hydrocarbon fluid from neighboring, lower permeability zones of the reservoir.

Herein, the term ‘thief zone’ refers to any region of high permeability relative to the permeabilities of the surrounding rock, such that a high proportion of the injected aqueous fluid flows through these regions. Such thief zones typically cannot be characterized by absolute values of permeability as the problem arises as a result of heterogeneity in the permeability of the reservoir rock; thus, a thief zone may simply be a region of higher permeability than the majority of the reservoir rock.

In order to improve sweep efficiency, these ‘thief zones’ can be partially or totally blocked deep in the reservoir, generating a new pressure gradient and diverting flow of subsequently injected aqueous fluid into lower permeability zones (layers or areas) of the reservoir with high hydrocarbon fluid (oil) saturation. Herein, sweep efficiency is taken to mean a measure of the effectiveness of a secondary or tertiary oil recovery process that depends on the proportion of the volume of the pore space of the reservoir contacted by the injected aqueous fluid.

Flow diversion involves changing the path of the injected aqueous fluid through the reservoir so that it contacts and displaces more hydrocarbon fluid (oil). Various physical and chemical treatment methods have been used to divert injected aqueous fluids from thief zones.

A few “deep reservoir flow diversion” processes have been developed with the aim of reducing the permeability in a substantial proportion of the thief zone at a significant distance from the injection and production wells. For example, the use of swellable cross-linked superabsorbent polymer microparticles for modifying the permeability of subterranean formations is disclosed in U.S. Pat. Nos. 5,465,792 and 5,735,349. Deep reservoir flow diversion may also be achieved by injecting polymeric microparticles comprising polymeric chains linked together via thermally labile hydrolysable crosslinkers and non-thermally labile crosslinkers, as disclosed in U.S. Pat. Nos. 6,454,003, 6,729,402, 6,984,705 and 7,300,973. The suspension of microparticles travels through the thief zones and is progressively heated to a temperature at which the thermally labile crosslinkers hydrolyze and are broken and the microparticles absorb water, swell and block the pores of the reservoir rock. The permeability of the thief zone is thereby reduced and subsequently injected fluid is diverted into the lower permeability zones to displace hydrocarbon fluids towards a producing well. However, a feature of these expandable microparticles is that the block is permanent. In other words, the microparticles have no ability to shrink back to their original size and move to another location in the reservoir matrix rock and then re-expand to form a further block.

GB 2 262 117A describes certain latex microparticles that are temperature sensitive and reversibly flocculate, shrink and harden at higher temperatures, and disperse, expand and soften at lower temperatures and that these can form effective blocking agents in the presence of an ionic compound, in a petroleum reservoir. An advantage of the latex microparticles of GB 2 262 117A is that the block is reversible. This is because the microparticles deflocculate as the reservoir matrix cools in the vicinity of the original block such that the deflocculated microparticles become redispersed in the injection water and the resulting dispersion can propagate through the formation to set up a subsequent block deeper within the formation where the temperature is sufficiently high to promote reflocculation, shrinkage and hardening of the latex microparticles. However, a problem with the dispersions of GB 2 262 117A is that they are produced at the desired particle concentration for the fluid that is to be injected into the reservoir. Large amounts of the dispersion of GB 2 262 117 A would be required for the treatment of a reservoir. Accordingly, the cost of handling and shipping the required volume of dispersion renders the treatment uneconomic. Accordingly, the method of GB 2 262 117A has yet to be commercially deployed.

It has been reported (Schulz, D. N.; Peiffer, D. G.; Agarwal, P. K.; Larabee, J.; Kaladas, J. J.; Soni, L.; Handwerker, B.; Garner, R. T. Polymer 1986, 27, 1734 and Huglin, M. B.; Radwan, M. A. Polymer International 1991, 26, 97) that polysulfobetaines exhibit temperature responsive solubility in aqueous fluids and have an Upper Critical Solution Temperature (UCST) above which the polysulfobetaines transition from being insoluble to soluble in water.

A synthetic method for the preparation of particles having a low level of incorporation of sulfobetaine groups (up to 8%) is disclosed in “Zwitterionic Poly(betaine-N-isopropylacrylamide) Microgels: Properties and Applications”, Das, M.; Sanson, N.; Kumacheva, E. Chemistry of Materials 2008, 20, 7157). The behavior of these particles is dominated by the properties of the non-botanized structural units (units derived from N-isopropylacrylamide) such that the particles exhibit Lower Critical Solution Temperature (LCST) behavior not UCST behavior.

It has also been reported (Arjunan Vasantha, V.; Junhui, C.; Ying, T. B.; Parthiban, A. Langmuir 2015, 31, 11124 and Vasantha, V. A.; Jana, S.; Parthiban, A.; Vancso, J. G. RSC Advances 2014, 4, 22596) that linear polysulfabetaines exhibit temperature responsive behavior in aqueous fluids.

The use of reversible addition-fragmentation chain transfer (RAFT) polymerization-induced self-assembly for the synthesis of UCST nanogels composed of a crosslinked poly(3-dimethyl(methacryloyloxyethyl)ammonium propane sulfonate (PDMAPS) core and a poly(poly(ethylene glycol)methyl ether methacrylate (PPEGMMA) corona has been reported (Wenxin Fu, Chunhui Luo, Emily A Morin, Wei He, Zhibo Li and Bin Zhao, ACS Macro Lett. 2017, 6, 127-133). PPEGMMA with a dithiobenzoate end-group was used as a chain-transfer agent to polymerize DMAPS in a mixture of H₂O and a water-miscible organic solvent (ethanol or THF) with N,N′-methylenebis(acrylamide) (MBAc) as cross-linker. Although, the particles exhibit an UCST and are reported to swell and shrink when dispersed in water, the increase in particle size is relatively small. There is also no report of the particles forming aggregates. Accordingly, the reported nanogels are not suitable for use in blocking thief zones of a reservoir.

Accordingly, a need exists for methods and compositions which overcome or at least mitigate the disadvantages associated with conventional methods for reducing the permeability of a thief zone, and may help increase or improve the recovery of hydrocarbon fluids from a reservoir. Desirably, such compositions enable production of a reversible block, enable injection of a concentrated form of the composition, provide a large increase in particle volume upon expansion within a thief zone, and/or produce aggregates.

### “Intentionally Left Blank”

### SUMMARY

Herein disclosed are polymeric microparticles comprising crosslinked copolymer chains comprising structural units derived from: (i) a water-soluble or water-dispersible monomer comprising a betaine group, (ii) a water-insoluble monomer, and, (iii) a cross-linking monomer comprising at least two sites of ethylenic unsaturation, wherein the polymeric microparticles comprise from 10 to 40 mole percent (mol %) of units derived from the monomer comprising the betaine group, and wherein the polymeric microparticles have a transition temperature which is a temperature greater than or equal to which the microparticles expand in size.

Also disclosed herein is a dispersion comprising the herein-disclosed polymeric microparticles. In embodiments, therefore, herein disclosed is a dispersion of polymeric microparticles in an aqueous fluid, wherein the polymeric microparticles comprise: crosslinked copolymer chains comprising structural units derived from (i) a water-soluble or water-dispersible monomer comprising a betaine group, (ii) a water-insoluble monomer, and, (iii) a cross-linking monomer having at least two sites of ethylenic unsaturation, wherein the polymeric microparticles comprise from 10 to 40 mole percent (mol %) of units derived from the monomer comprising the betaine group, and wherein the polymeric microparticles have a transition temperature which is a temperature greater than or equal to which the microparticles expand in size.

Further disclosed herein is a process for recovering hydrocarbon fluids from a porous and permeable subterranean petroleum reservoir, the process comprising: (a) injecting a dispersion of polymeric microparticles in an aqueous fluid into a higher permeability zone of a reservoir from an injection well or from a production well, wherein the reservoir comprises the higher permeability zone and a lower permeability zone, wherein the higher permeability zone has a permeability above that of the lower permeability zone, wherein the higher permeability zone and the lower permeability zone are penetrated by the injection well and the production well, wherein the polymeric microparticles comprise crosslinked copolymer chains comprising structural units derived from (i) a water-soluble or water-dispersible monomer comprising a betaine group, (ii) a water-insoluble monomer, and, (iii) a cross-linking monomer comprising at least two sites of ethylenic unsaturation, wherein a mole percent (mol %) of structural units derived from the monomer comprising the betaine group lies within the range of from 10 to 40 mol % based on a total molar amount of structural units in the copolymer chains, wherein the polymeric microparticles have a transition temperature, which is a temperature greater than or equal to which the microparticles expand in size, wherein the injection well has a maximum temperature below the transition temperature and the higher permeability zone comprises a region between the injection well and the production well that has a temperature greater than or equal to the transition temperature; (b) propagating the dispersion through the higher permeability zone until the dispersion reaches the region of the higher permeability zone having the temperature at or above the transition temperature such that the polymeric microparticles expand in size thereby reducing the permeability of the higher permeability zone of the reservoir; (c) diverting subsequently injected aqueous fluid from the higher permeability zone into the lower permeability zone of the reservoir; and (d) recovering hydrocarbon fluids from said at least one production well.

Also disclosed herein is a method for preparing the polymeric microparticles by emulsion polymerization of (i) a water-soluble or water-dispersible monomer comprising a betaine group, (ii) a water-insoluble monomer and (iii) a crosslinking monomer comprising at least two sites of ethylenic unsaturation in the presence of a radical initiator, wherein droplets of an oil phase comprising the water-insoluble monomer and crosslinking monomer are dispersed in a continuous aqueous phase comprising a solution or dispersion of the water-soluble or water-dispersible monomer comprising the betaine group which acts as a reactive stabilizer for the emulsion droplets, and wherein the mole percent (mol %) of the monomer with the betaine group is from 10 to 40 mol % based on the total moles of monomer.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a schematic of the synthesis of microparticles comprising crosslinked copolymer chains having structural units derived from (N,N′-dimethyl(methacryloylethyl)ammonium propane sulfonate (DMAPS) monomer, 2-(diethylamino)ethyl methacrylate (DEAEMA) monomer and ethylene glycol dimethacrylate (EGDMA) crosslinking monomer;

FIG. 2 shows DLS analyses of PDMAPS-co-PDEAEMA crosslinked microparticles with 20, 25, 30 and 40 wt % (14, 18, 22, 31 mol %) DMAPS incorporation;

FIG. 3 shows changes in the diameter of PDMAPS-co-PDEAEMA crosslinked microparticles with 14, 22 and 31 mol % DMAPS incorporation with changing temperature when the microparticles are dispersed in deionized water;

FIG. 4 shows changes in the diameter of PDMAPS-co-PDEAEMA crosslinked microparticles with changing temperature when the microparticles are dispersed in a 0.3 M sodium chloride solution, in a low salinity brine, and in deionized water;

FIG. 5 shows the synthesis of microparticles comprising crosslinked copolymer chains having structural units derived from methacryloylethyl phosphorylcholine (MPC) monomer, 2-(diethylamino)ethyl methacrylate (DEAEMA) monomer and ethylene glycol dimethacrylate (EGDMA) crosslinking monomer;

FIG. 6 shows DLS analysis of PMPC-co-PDEAEMA crosslinked microparticles; and

FIG. 7 shows changes in the diameter of PMPC-co-PDEAEMA crosslinked microparticles with changing temperature when the microparticles are dispersed in deionized water.

### DETAILED DESCRIPTION

It should be understood at the outset that although an illustrative implementation of one or more exemplary embodiments is provided below, the disclosed compositions, methods, and/or products may be implemented using any number of techniques, whether currently known or in existence. The disclosure should in no way be limited to the illustrative implementations, drawings, and techniques illustrated hereinbelow, including the exemplary designs and implementations illustrated and described herein, but may be modified within the scope of the appended claims along with their full scope of equivalents.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” and “such as” are used in an open-ended fashion, and thus should be interpreted to mean “including, but not limited to . . . .”

As utilized herein, the ‘transition temperature’ is the temperature at which expansion and aggregation of the herein-disclosed dispersed microparticles is induced.

As utilized herein, the term ‘thief zone’ refers to any region of high permeability relative to the permeabilities of the surrounding rock, such that a high proportion of an injected aqueous fluid preferentially flows through these regions.

According to embodiments of this disclosure, there is provided a process for recovering hydrocarbon fluids from a porous and permeable subterranean petroleum reservoir comprising at least one higher permeability zone and at least one lower permeability zone that are penetrated by at least one injection well and at least one production well, the process comprising: (a) injecting a dispersion of polymeric microparticles in an aqueous fluid into the higher permeability zone of the reservoir from the injection well or from the production well wherein the polymeric microparticles comprise crosslinked copolymer chains having structural units derived from (i) a water-soluble or water-dispersible monomer with a betaine group, (ii) a water-insoluble monomer, and, (iii) a cross-linking monomer having at least two sites of ethylenic unsaturation, wherein the polymeric microparticles have a transition temperature at which the microparticles expand in size and wherein the injection well has a maximum temperature below the transition temperature and the higher permeability zone has a region between the injection well and production well having a temperature at or above the transition temperature; (b) propagating the dispersion through the higher permeability zone until the dispersion reaches the region of the higher permeability zone having the temperature at or above the transition temperature such that the polymeric microparticles expand in size thereby reducing the permeability of the higher permeability zone of the reservoir; (c) diverting subsequently injected aqueous fluid from the higher permeability zone into the lower permeability zone of the reservoir; and (d) recovering hydrocarbon fluids from said at least one production well.

In the event that the dispersion of polymeric microparticles is injected into the higher permeability zone from the production well, the person skilled in the art will understand that the production well is taken off production before the dispersion is injected down the production well and into the higher permeability zone of the reservoir.

The polymeric microparticles of the dispersion are temperature responsive microparticles which exhibit a change in solvation and consequently an increase in particle size when dispersed in water that is at a temperature at or above the transition temperature. The expanded microparticles may then aggregate to form aggregates thereby aiding the formation of a block to water in the thief zone.

The initial (unexpanded) size of the polymeric microparticles employed in the method of embodiments of this disclosure may be such that, prior to encountering a temperature within the thief zone (higher permeability zone) that is at or greater than the transition temperature of the microparticles, efficient propagation of the composition through the pore structure of the reservoir rock, such as sandstone or carbonate, can be achieved. Thus, the polymeric microparticles may propagate through low temperature regions of the thief zone (higher permeability zone) of the reservoir substantially unimpeded. Typically, the initial average particle diameter of the microparticles is in the range of 0.05 to 1 μm, for example, 0.1 to 1 μm.

Once the dispersion reaches a region of the thief zone (higher permeability zone), having a temperature at or above the transition temperature, the microparticles become solvated and expand in size. Typically, the expanded microparticles then aggregate. Typically, the individual expanded microparticles have an average particle diameter in the range of 1 to 10 microns. In embodiments, the ratio of the average particle diameter of the individual expanded microparticles to the initial average particle diameter of the unexpanded individual microparticles is at least 2:1 or at least 3:1. In embodiments, the ratio of the volume of the individual expanded microparticles to the initial volume of the unexpanded individual microparticles is at least 5:1, at least 10:1, or at least 20:1.

Suitably, the aggregates of expanded microparticles have an average particle diameter of at least 1000 nm or at least 2000 nm. In embodiments, the aggregates of expanded microparticles have an average particle diameter in the range of 1000 to 10000 nm.

Without wishing to be bound by any theory, the temperature at which the individual microparticles begin to expand may be below the temperature at which the microparticles begin to aggregate, for example, may be 10° C. below the aggregation temperature. Accordingly, by “transition temperature” is meant the temperature at which aggregates are formed, for example, as determined in a laboratory experiment.

Suitably, the region of the thief zone (higher permeability zone), having a temperature above the transition temperature, is not so close to the injection well as to reduce injectivity of the dispersion and not so close to the production well that only a minor portion of the thief zone (higher permeability zone) of the reservoir is swept by the subsequently injected aqueous fluid. In embodiments, the region of the thief zone having a temperature above the transition temperature is at least several meters, for example, at least 10 meters from the injection well or production well. Typically, aqueous injection fluids are at a lower temperature than the petroleum reservoir such that a previously injected aqueous fluid cools the reservoir giving rise to a temperature front in the reservoir which typically increases in radial distance from the injection well over time. The temperature front in the higher permeability zone (thief zone) is likely to be ahead of the temperature front in the lower permeability zone of the reservoir owing to the higher amounts of injected aqueous fluid that permeate through the thief zone. In embodiments, the region of the thief zone that is at a temperature at or above the transition temperature is beyond the temperature front in the thief zone.

Suitably, in the process according to embodiments of this disclosure, the maximum temperature in the well (from which the dispersion is injected into the higher permeability zone) is less than or equal to 30° C. or less than or equal to 25° C. In embodiments, the dispersion is injected into the well at a temperature in the range of 4 to 25° C. In embodiments, the dispersion injected into the well comprises polymeric microparticles with a transition temperature of at least 30° C. when dispersed in the aqueous fluid of the dispersion.

Without wishing to be bound by any theory, the transition temperature for the microparticles of the dispersion may be dependent of the salinity (total dissolved solids content) of the aqueous fluid of the dispersion with the transition temperature increasing with increasing salinity.

Suitably, the aqueous fluid of the dispersion may be low salinity water having a total dissolved solids content of less than 10,000 mg/L, less than 5000 mg/L, or less than 3000 mg/L. Suitably, the aqueous fluid of the dispersion is a low salinity water having a total dissolved solids content in the range of from 500 to 3000 mg/L, or from 500 to 1000 mg/L. Suitably, the aqueous fluid of the dispersion may have a content of multivalent inorganic cations of up to 50 mol % (based on the total moles of inorganic cations in the aqueous fluid). Suitably, the multivalent cations in the aqueous fluid are divalent cations, such as, magnesium and calcium cations.

In embodiments, the process this disclosure may be particularly suitable for the recovery of hydrocarbon fluids, such as crude oil, from subterranean petroleum reservoirs containing at least one high permeability zone between said at least one injection well and said at least one production well having a region with a temperature of at least 30° C., at least 40° C., at least 50° C., at least 60° C. or greater with the proviso that the temperature is greater than the transition temperature for the polymeric microparticles of the dispersion.

Without wishing to be bound by any theory, the transition temperature of the microparticles of the dispersion used in the process of this disclosure may be adjusted to match the temperature conditions encountered in the thief zone of a particular reservoir by: (a) varying the amount of structural units derived from the monomer with a betaine group in the crosslinked copolymer chains as the transition temperature was found to increase with increasing amounts of structural units in the crosslinked copolymer chains that are derived from the monomer with the betaine group; (b) varying the chemical structure of the units derived from the monomer with the betaine group; and/or (c) by changing the type of water-insoluble comonomer used in the preparation of the microparticles.

In embodiments, the amount of structural units derived from the monomer with a betaine group in the crosslinked copolymer chains is in the range of from 10 to 40 mole percent (mol %), or from 12.5 to 35 mol % (based on the total molar amount of structural units). Microparticles comprising copolymer chains with these levels of structural units derived from a monomer with a betaine group typically have transition temperatures in the range of from 15 to 90° C., from 20 to 90° C., or from 30 to 80° C. Thus, microparticles are selected having crosslinked copolymer chains having a mol % of structural units derived from the monomer with a betaine group that provides a transition temperature for the microparticles that matches the temperature in the region of the high permeability zone between the injection well and production well.

In embodiments of the method of this disclosure, most of the composition comprising the polymeric microparticles dispersed in an aqueous fluid will enter the thief zone of the reservoir since the composition will follow the most permeable and/or lowest pressure route or routes from the injection well to an associated production well. When the microparticles expand and aggregate in the region of the thief zone having a temperature above the transition temperature, they form a block to water. Thus, the permeability of water through the block of expanded and aggregated microparticles is lower than the permeability of water through neighboring zones of the reservoir such that subsequently injected aqueous fluid (water injected into the reservoir after the dispersion) is largely diverted out of the thief zone and into neighboring zones.

Advantageously, aggregation of the herein-disclosed microparticles may be reversible such that cooling of the thief zone in the location of the block to a temperature below the transition temperature may result in disaggregation of the microparticles. Expansion of the microparticles may also be reversible such that cooling of the thief zone in the location of the block to a temperature below the transition temperature results in desolvation of the microparticles and consequently contraction (shrinkage) of the microparticles.

The person skilled in the art will understand that cooling of the thief zone in the location of the block may occur due to a subsequently injected water flowing through neighboring zones of the reservoir such that the temperature front in the neighboring zones advances through the reservoir until it is adjacent the region of the thief zone containing the block thereby cooling the thief zone in the location of the block. Accordingly, the disaggregated and contracted microparticles may become redispersed in water and the resulting dispersion may permeate through the thief zone until it reaches another location (region) where the temperature is at or above the transition temperature where the microparticles again expand in size and aggregate. These steps of expansion, aggregation, disaggregation, contraction and redispersion may occur a plurality of times within the thief zone, thereby allowing a greater volume of the reservoir to be swept by the subsequently injected water.

In a further aspect of this disclosure, there is provided a dispersion of polymeric microparticles in an aqueous fluid wherein the polymeric microparticles comprise crosslinked copolymer chains having structural units derived from (i) a water-soluble or water-dispersible monomer with a betaine group, (ii) a water-insoluble monomer, and, (iii) a cross-linking monomer having at least two sites of ethylenic unsaturation and wherein the polymeric microparticles have from 10 to 40 mol % of units derived from the monomer with the betaine groups and wherein the microparticles expand in size and aggregate at above a transition temperature.

The person skilled in the art will understand that the term “aqueous fluid” as used herein is intended to mean any water or aqueous solution suitable for use in a water flooding process in either secondary or tertiary (EOR) recovery mode.

The dispersion of polymeric microparticles in the aqueous fluid is of relatively low viscosity and can be injected into the porous and permeable subterranean petroleum reservoir at relatively low injection pressures, with the proviso that the injection pressure is maintained above the pressure within the pore space of the subterranean reservoir.

In yet a further aspect of this disclosure, there is provided polymeric microparticles comprising crosslinked copolymer chains having structural units derived from (i) a water-soluble or water-dispersible monomer with a betaine group, (ii) a water-insoluble comonomer, and, (iii) a cross-linking monomer having at least two sites of ethylenic unsaturation and wherein the polymeric microparticles have from 10 to 40 mol % of units derived from the monomer with the betaine group and the polymeric microparticles expand in size and aggregate when dispersed in an aqueous fluid at above a transition temperature.

In accordance with an embodiment of this disclosure, the polymeric microparticles may be prepared by an emulsion polymerization process in order to control the particle size distribution of the microparticles. An emulsion polymerization process is a polymerization process in which water-insoluble monomer (or a solution of water-insoluble monomer in an oil phase) is added to an aqueous phase containing a stabilizer that stabilizes the emulsion. The resulting emulsion consists of a discontinuous phase (also referred to as “disperse phase”) comprising small droplets of water-insoluble monomer (or a solution of water-insoluble monomer in an oil phase), dispersed in a continuous aqueous phase wherein the droplets typically have a diameter of greater than 100 nm (0.1 micron) and less than 10 microns or less than 2 microns. Typically, the emulsion polymerization occurs with the application of shear, for example, by carrying out the emulsion polymerization reaction in a stirred tank reactor vessel.

Thus, in yet a further embodiment of this disclosure, there is provided a method for preparing the polymeric microparticles by emulsion polymerization of (i) a water-soluble or water-dispersible monomer with a betaine group, (ii) a water-insoluble comonomer and (iii) a crosslinking monomer having at least two sites of ethylenic unsaturation, in the presence of a radical initiator wherein the mol % of the monomer with the betaine group is from 10 to 40 mol % based on the total moles of monomer.

Accordingly, the emulsion polymerization reaction mixture comprises: (a) water; (b) at least one water-soluble or water-dispersible monomer having a betaine group; (c) at least one water-insoluble or water-immiscible crosslinking monomer having at least two sites of ethylenic unsaturation; (d) a water-insoluble comonomer; (e) optionally, a water-insoluble organic solvent in which water-insoluble monomer and crosslinking monomer are dissolved; and (f) optionally, a non-reactive stabilizer (also referred to in the art as a surfactant).

The person skilled in the art will understand that the mol % of structural units derived from the various monomers in the polymeric microparticles will correspond to the mol % of the various monomers in the emulsion polymerization reaction mixture. Thus, the amount of structural units derived from the monomer having the betaine group may be increased by increasing the mol % of this monomer in the emulsion polymerization reaction mixture (based on the total moles of monomer).

The water-insoluble comonomer and water-insoluble cross-linking monomer are optionally dissolved in the water-insoluble organic solvent. Suitable water-insoluble organic solvents include benzene, toluene, cyclohexane, and mixtures thereof. Thus, the oil phase of the emulsion may comprise undiluted water-insoluble comonomer and water-insoluble crosslinking monomer or a solution of the water-insoluble comonomer and water-insoluble crosslinking monomer in the water-insoluble organic solvent.

Suitably, the water-soluble or water-dispersible monomer having the betaine group serves as a stabilizer (emulsifier) for the emulsion polymerization process by stabilizing the emulsion droplets. Thus, the monomer with the betaine group is a reactive stabilizer.

It is also envisaged that the emulsion polymerization reaction medium may optionally include a non-reactive stabilizer provided that the non-reactive stabilizer is compatible with the reactive stabilizer. Examples of the optional non-reactive stabilizers include surfactants such as sorbitan esters of fatty acids, ethoxylated sorbitan esters of fatty acids, alkyl sulfates, alkyl ether sulfates, alkyl betaine surfactants, for example, alkyl sulfobetaine surfactants or mixtures thereof. Examples of non-reactive surfactants include ethoxylated sorbitol oleate, sorbitan sesquioleate, and sodium dodecylsulfate (SDS), polyoxyethylene sorbitan monooleate (Tween 80) and sorbitane monooleate (Span 80).

The monomer with the betaine group (hereinafter “betaine monomer”) may be any water-soluble or water-dispersible betaine vinyl monomer having the formulae:

CH₂═C(R)C(O)OR₂N⁺R′R″R₃X⁻ (I); or

CH₂═C(R)C(O)NHR₂N⁺R′R″R₃X⁻ (II),

wherein: R is selected from hydrogen and an alkyl group having from 1 to 3 carbon atoms, for example, methyl; R₂ and R₃ are alkylene groups, such as C₂ to C₆ alkylene groups, and are, in embodiments, independently selected from ethylene, n-propylene or n-butylene groups; R′ and R″ are independently selected from alkyl groups having from 1 to 3 carbon atoms, such as, methyl and ethyl (e.g., methyl); or N⁺, R′ and R″ together form a saturated heterocyclic ammonium ring, optionally, having an oxygen heteroatom in the ring, for example, a piperidinium or morpholinium ring; and X is selected from sulfo (—SO₃⁻), carboxy (—COO⁻), sulfa (—OSO₃⁻), phospho (—OPO₃⁻) and phosphonate (—PO₃⁻) groups.

Examples of sulfobetaine vinyl monomers of formula (I) include:
N,N′-dimethyl(methacryloylethyl)ammonium propane sulfonate,
N,N′-diethyl(methacryloylethyl)ammonium propane sulfonate,
N,N′-dimethyl(methacryloylethyl)ammonium ethane sulfonate,
N,N′-diethyl(methacryloylethyl)ammonium ethane sulfonate,
N,N′-dimethyl(methacryloylethyl)ammonium butane sulfonate, and
N,N′-diethyl(methacryloylethyl)ammonium butane sulfonate.

A suitable sulfobetaine vinyl monomer of formula (I) is N,N′-dimethyl(methacryloylethyl)ammonium propane sulfonate (DMAPS).

Examples of carboxybetaine vinyl monomers of formula (I) include:
N,N′-dimethyl(methacryloylethyl)ammonium propane carboxylate,
N,N′-diethyl(methacryloylethyl)ammonium propane carboxylate,
N,N′-dimethyl(methacryloylethyl)ammonium ethane carboxylate,
N,N′-diethyl(methacryloylethyl)ammonium ethane carboxylate,
N,N′-dimethyl(methacryloylethyl)ammonium butane carboxylate, and
N,N′-diethyl(methacryloylethyl)ammonium butane carboxylate.

Examples of sulfabetaine vinyl monomers of formula (I) include:
N,N′-dimethyl(methacryloylethyl)ammonium propane sulfate,
N,N′-diethyl(methacryloylethyl)ammonium propane sulfate,
N,N′-dimethyl(methacryloylethyl)ammonium ethane sulfate,
N,N′-diethyl(methacryloylethyl)ammonium ethane sulfate,
N,N′-dimethyl(methacryloylethyl)ammonium butane sulfate, and
N,N′-diethyl(methacryloylethyl)ammonium butane sulfate.

Examples of phosphobetaine vinyl monomoners of formula (I) include:
N,N′-dimethyl(methacryloylethyl)ammonium propane phosphate,
N,N′-diethyl(methacryloylethyl)ammonium propane phosphate,
N,N′-dimethyl(methacryloylethyl)ammonium ethane phosphate,
N,N′-diethyl(methacryloylethyl)ammonium ethane phosphate,
N,N′-dimethyl(methacryloylethyl)ammonium butane phosphate, and
N,N′-diethyl(methacryloylethyl)ammonium butane phosphate.

Examples of phosphonate vinyl betaine monomoners of formula (I) include:
N,N′-dimethyl(methacryloylethyl)ammonium propane phosphonate,
N,N′-diethyl(methacryloylethyl)ammonium propane phosphonate,
N,N′-dimethyl(methacryloylethyl)ammonium ethane phosphonate,
N,N′-diethyl(methacryloylethyl)ammonium ethane phosphonate,
N,N′-dimethyl(methacryloylethyl)ammonium butane phosphonate, and
N,N′-diethyl(methacryloylethyl)ammonium butane phosphonate.

Examples of sulfobetaine vinyl monomers of formula (II) include:
N,N′-dimethyl(methacrylamide propyl)ammonium propane sulfonate,
N,N′-diethyl(methacrylamide propyl)ammonium propane sulfonate,
N,N′-dimethyl(methacrylamide propyl)ammonium ethane sulfonate,
N,N′-diethyl(methacrylamide propyl)ammonium ethane sulfonate,
N,N′-dimethyl(methacrylamide propyl)ammonium butane sulfonate, and
N,N′-diethyl(methacrylamide propyl)ammonium butane sulfonate.

Examples of carboxybetaine vinyl monomers of formula (II) include:
N,N′-dimethyl(methacrylamide propyl)ammonium propane carboxylate,
N,N′-diethyl(methacrylamide propyl)ammonium propane carboxylate,
N,N′-dimethyl(methacrylamide propyl)ammonium ethane carboxylate,
N,N′-diethyl(methacrylamide propyl)ammonium ethane carboxylate,
N,N′-dimethyl(methacrylamide propyl)ammonium butane carboxylate, and
N,N′-diethyl(methacrylamide propyl)ammonium butane carboxylate.

Examples of sulfabetaine vinyl monomers of formula (II) include:
N,N′-dimethyl(methacrylamide propyl)ammonium propane sulfate,
N,N′-diethyl(methacrylamide propyl)ammonium propane sulfate,
N,N′-dimethyl(methacrylamide propyl)ammonium ethane sulfate,
N,N′-diethyl(methacrylamide propyl)ammonium ethane sulfate,
N,N′-dimethyl(methacrylamide propyl)ammonium butane sulfate, and
N,N′-diethyl(methacrylamide propyl)ammonium butane sulfate.

Examples of phosphobetaine vinyl monomoners of formula (II) include:
N,N′-dimethyl(methacrylamide propyl)ammonium propane phosphate,
N,N′-diethyl(methacrylamide propyl)ammonium propane phosphate,
N,N′-dimethyl(methacrylamide propyl)ammonium ethane phosphate,
N,N′-diethyl(methacrylamide propyl)ammonium ethane phosphate,
N,N′-dimethyl(methacrylamide propyl)ammonium butane phosphate, and
N,N′-diethyl(methacrylamide propyl)ammonium butane phosphate.

Examples of phosphonate vinyl betaine monomoners of formula (II) include:
N,N′-dimethyl(methacrylamide propyl)ammonium propane phosphonate,
N,N′-diethyl(methacrylamide propyl)ammonium propane phosphonate,
N,N′-dimethyl(methacrylamide propyl)ammonium ethane phosphonate,
N,N′-diethyl(methacrylamide propyl)ammonium ethane phosphonate,
N,N′-dimethyl(methacrylamide propyl)ammonium butane phosphonate, and
N,N′-diethyl(methacrylamide propyl)ammonium butane phosphonate.

Examples of sulfobetaine monomers of formula (I) and (II) wherein N+, R′ and R″ together form a saturated heterocyclic ammonium ring include:

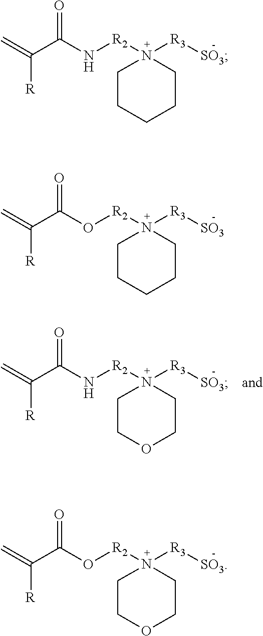

The person skilled in the art will understand that the SO3⁻ group of the above monomers may be replaced by a carboxy (—COO⁻), sulfa (—OSO₃⁻), phospho (—OPO₃⁻) or phosphonate (−PO₃⁻) group.

Alternatively, the betaine monomer may be a water-soluble or water-dispersible phosphobetaine vinyl monomer having the following general formulae:

CH₂═C(R)C(O)OR₂—OP(O)(O⁻)O—R₃NR′R″R′″ (III); or

CH₂═C(R)C(O)NHR₂—OP(O)(O⁻)O—R₃NR′R″R′″ (IV)

wherein R, R₂, R₃, R′ and R″ are as defined above for general formula I, and R′″ is selected from an alkyl group having from 1 to 3 carbon atoms, in embodiments, methyl and/or ethyl, in embodiments methyl.

Examples of betaine monomers of general formula (II) include: methacryloyloxyethyl phosphorylcholine (MPC); methacryloyloxypropyl phosphorylcholine; methacrylamide ethyl phosphorylcholine (MPC); and, methacrylamide propyl phosphorylcholine.

Typically, the water-soluble or water-dispersible monomer with a sulfobetaine group, comprises from 10 to 40 mol % of the total moles of betaine monomer and comonomer in the emulsion polymerization reaction mixture. In embodiments, the mol % of monomer with the sulfobetaine group in the polymerization reaction mixture is from 15 to 35 mol %, or from 20 to 35 mol % (based on the total moles of betaine monomers and comonomer in the emulsion polymerization reaction mixture).

Suitably, the mol % of water-insoluble comonomer in the emulsion polymerization mixture is in the range of from 50 to 90 mol %, from 60 to 80 mol %, or from 65 to 75 mol %.

The water-insoluble comonomer used to prepare the microparticles may be selected from dialkylaminoalkyl alkacrylate, dialkylaminoalkyl alkacrylamide, alkyl alkacrylate and alkyl alkacrylamide monomers.

In embodiments, the water-insoluble comonomer used to prepare the microparticles may be selected from dialkylaminoalkyl alkacrylates of general formula [H₂C═C(CH₃)CO₂R₄NR⁵R⁶] (V) and dialkylaminoalkyl alkacrylamides of general formula [H₂C═C(CH₃)CONHR₄NR⁵R⁶] (VI) wherein R₄ is a straight chain alkylene moiety having from 1 to 5 carbon atoms that is optionally substituted by methyl; and R⁵ and R⁶ are independently selected from methyl, ethyl, n-propyl and isopropyl. In embodiments, R₄ is a methylene or ethylene moiety. In embodiments, R⁵ and R⁶ are independently selected from methyl and ethyl. In embodiments, R⁵ and R⁶ are methyl.

Examples of dialkylaminoalkyl alkacrylates of general formula (V) that may be used in the synthesis of the microparticles in accordance with this disclosure include:
3-(dimethylamino)propyl methacrylate [H₂C═C(CH₃)CO₂(CH₂)₃N(CH₃)₂];
3-(diethylamino)propyl methacrylate [H₂C═C(CH₃)CO₂(CH₂)₃N(H₂CH₂CH₃)₂];
3-(diisopropylamino)propyl methacrylate [H₂C═C(CH₃)CO₂(CH₂)₃N(CH(CH₃)₂)₂].
2-(dimethylamino)ethyl methacrylate [H₂C═C(CH₃)CO₂(CH₂)₂N(CH₃)₂];
2-(diethylamino)ethyl methacrylate [H₂C═C(CH₃)CO₂(CH₂)₂N(H₂CH₂CH₃)₂];
2-(diisopropylamino)ethyl methacrylate [H₂C═C(CH₃)CO₂(CH₂)₂N(CH(CH₃)₂)₂].

Examples of dialkylaminoalkacrylamides of general formula (VI) that may be used in the synthesis of the microparticles in accordance with this disclosure include:
3-(dimethylamino)propyl methacrylamide [H₂C═C(CH₃)CONH(CH₂)₃N(CH₃)₂];
3-(diethylamino)propyl methacrylamide [H₂C═C(CH₃)CONH(CH₂)₃N(CH₂CH₃)₂];
2-(dimethylamino)ethyl methacrylamide [H₂C═C(CH₃)CONH(CH₂)₂N(CH₃)₂]; and
2-(diethylamino)ethyl methacrylamide [H₂C═C(CH₃)CONH(CH₂)₂N(CH₂CH₃)₂].

Dialkylaminoalkyl alkacrylates and dialkylaminoalkacrylamides have betainizable functional groups such that the resulting microparticles may be optionally reacted with a betainization reagent selected from sulfobetainization, carboxybetainization, phosphobetainization, sulfabetainization reagents thereby introducing additional betaine groups into the polymeric microparticles. Methods of betainizing microparticles containing betainizable functional groups are disclosed in UK Patent Application No. 1612678.1 which is herein incorporated by reference.

In embodiments, the water-insoluble comonomer used to prepare the microparticles may be selected from dialkyl alkacrylates of general formula (VII):

H₂C═C(CH₃)CO₂R (VII),

wherein R is selected from a C₁ to C₄ alkyl group, for example, methyl, ethyl, and n-propyl.

In embodiments, the water-insoluble comonomer used to prepare the microparticles may be selected from dialkyl alkacrylamides of general formula (VIII):

H₂C═C(CH₃)CONHR (VIII),

wherein R is as defined for comonomers of general formula VII.

The person skilled in the art will understand that the cross-linking monomer forms covalent linkages between two copolymer chains and/or between different regions of the same copolymer chain. Structural units derived from the cross-linking monomers are included in the polymeric microparticles of embodiments of this disclosure to constrain the microparticle conformation at temperatures above the transition temperature thereby preventing the polymer chains from dissolving in the water contained in the pore space of the thief zone(s). Accordingly, the structural units derived from the “cross-linking monomer” are non-labile, i.e., are not degraded under the reservoir conditions, for example, are not degraded at the temperature of the thief zone(s) or at the pH of the water contained within the pore space of the thief zone(s).

In embodiments, the crosslinking monomer comprises from 0.1 to 10 mol %, from 0.5 to 3 mol %, or from 0.75 to 2 mol %, for example, from 1 to 2 mol % of the mixture of monomers used to prepare the microparticles.

Examples of crosslinking monomers that may be used to prepare the microparticles include diacrylamides and methacrylamides of diamines such as the diacrylamide or dimethacrylamide of piperazine or the diacrylamide or dimethacrylamide of methylenediamine; methacrylate esters of di, tri, tetra hydroxy compounds including ethyleneglycol dimethacrylate, polyethyleneglycol dimethacrylate, trim ethylolpropane trimethacrylate, and the like; divinylbenzene, 1,3-diisopropenylbenzene, and the like; the vinyl or allyl esters of di or trifunctional acids; and, diallylamine, triallylamine, divinyl sulfone, diethyleneglycol diallyl ether, and the like. Suitable non-labile cross linking monomers include ethyleneglycol dimethacrylate, methylene bisacrylamide and divinylbenzene.

The emulsion polymerization process may be initiated using a thermal or redox free-radical initiator. Suitable initiators include azo compounds, such as azobisisobutyronitrile (AIBN) and 4,4′-azobis(4-cyanovaleric acid) (ACVA); peroxides, such as di-t-butyl peroxide; inorganic compounds, such as potassium persulfate; and, redox couples, such as benzoyl peroxide/dimethylaminopyridine and potassium persulfate/sodium metabisulfite.

In embodiments, the polymerization initiator is present in the emulsion polymerization composition in an amount of from 0.01 to 10 mol % (based on the moles of monomers used to prepare the microparticles).

In addition to the monomers, cross-linkers, and polymerization initiator and optional non-reactive stabilizer(s), other conventional additives may be used in the synthesis of the microparticles, for instance pH adjusters, and chelating agents used to remove polymerization inhibitors.

The microparticles of this disclosure may be obtained in dry form by precipitation from the emulsion using a suitable solvent, such as isopropanol, acetone, isopropanol/acetone or methanol/acetone or other solvents or solvent mixtures that are miscible with both the hydrocarbon phase and aqueous phase of the emulsion. The microparticles may be isolated from the supernatant by centrifugation or filtration and may be dried by conventional procedures.

Suitable procedures for the preparation of the microparticles using emulsion polymerization processes are available in the art, and reference in this regard is made to U.S. Pat. Nos. 4,956,400, 4,968,435, 5,171,808, 5,465,792 and 5,737,349, which are hereby incorporated herein for purposes not contrary to his disclosure.

The dispersion according embodiments of this disclosure may be prepared by dispersing the microparticles in an aqueous fluid (for example, an injection water available at the injection site) at a temperature below the transition temperature of the microparticles, thereby forming a dispersion of the microparticles in the aqueous fluid. Agitation means, for example sonication, may be used to promote the formation of a stable dispersion.

The dispersion may also be prepared from a concentrate comprising the herein-disclosed polymeric microparticles at a higher concentration in an aqueous fluid than is intended for the injected composition. The concentrate may then be dosed into an injection water, for instance injection water located at the injection site, in order to prepare the composition that is to be injected into the thief zone of the reservoir.

Where the dispersion is formed by dispersing dried microparticles in an aqueous fluid, the dried microparticles may be dispersed in a water-miscible organic solvent to form a concentrated dispersion of the microparticles in the water-miscible organic solvent which is subsequently diluted into the aqueous fluid. Suitable water-miscible solvents include tetrahydrofuran, 1,3-butylene glycol, tetrahydrofurfuryl alcohol, ethylene glycol monobutyl ether, ethylene glycol methyl ether, mono ethylene glycol, and methyl ethyl ketone. Optionally, the water-miscible solvent may be subsequently removed from the diluted dispersion via a cross-flow ultrafiltration process, by a dialysis process or by evaporation.

If desired, a surfactant dispersant or a mixture of surfactant dispersants may be used to assist in dispersing either the dried microparticles or the concentrated dispersion of the microparticles in the water-miscible organic solvent in the aqueous fluid. Suitable surfactant dispersants are well known to the person skilled in the art and include sodium dodecylsulfate, nonylphenylethoxylates, polyoxyethylene-20-sorbitan monooleate, nonionic ethylene oxide/propylene oxide block copolymer surfactants, and zwitterionic surfactants such as cocamidopropyl hydroxysultaine and, in embodiments, betaine surfactants such as cocamidopropylbetaine.

The aqueous fluid may be any water suitable for injection into a subterranean formation via an injection well. For instance, the aqueous fluid may be fresh water, lake water, river water, estuarine water, brackish water, seawater, aquifer water, desalinated water, sulfate reduced water, produced water or mixtures thereof. The aqueous fluid may have a TDS of less than 20,000 ppmv (mg/L) or less than 17,000 ppmv (mg/L). However, it is also envisaged that the microparticles may be formulated to solvate, expand in size and aggregate in higher salinity waters such as seawater.

As the skilled person will appreciate, the composition may also be prepared by separately adding the surfactant dispersant(s) and microparticles into the aqueous fluid. In that case, the surfactant(s) are typically added to the aqueous fluid prior to addition of the microparticles.

The person skilled in the art will recognize that the physical properties of the microparticles, for example, their size, dispersivity and transition temperature, can be tailored to the conditions encountered in the thief zone of the reservoir.

The particle size distribution of the microparticles can be varied by varying the size of the emulsion droplets in the emulsion polymerization process used to prepare the microparticles. This may be achieved by varying the stirring method or stirrer speed used in the emulsion polymerization process. Suitable methods of stirring the emulsion include the use of magnetic stirrers or paddle stirrers. The particle size distribution may also be varied by varying the reactive stabilizer (monomer with the betaine group), the optional non-reactive stabilizer (surfactant), the optional hydrocarbon liquid solvent, the water-insoluble monomer and the concentration of monomers used in the emulsion polymerization process. Such methods of varying the particle size distribution are well known to the person skilled in the art.

The dispersivity of the microparticles may be varied by changing the amount or type of reactive stabilizer (monomer with the betaine group) used in the preparation of the microparticles and/or the amount or type of surfactant employed when dispersing the microparticles or concentrate comprising the microparticles into the aqueous fluid.

Without wishing to be bound by any theory, the transition temperature of the microparticles may be varied by varying one or more of: (a) the mole percent of betaine monomer used in the preparation of the microparticles by emulsion polymerization and hence the mole percent of units derived from this monomer in the cross-linked copolymer chains of the microparticles; (b) the mole percent of crosslinking monomer used in the preparation of the microparticles by emulsion polymerization and hence the extent of crosslinking of the copolymer chains; (c) the chemical structure of the betaine monomer used in the preparation of the microparticles by emulsion polymerization; and (d) the chemical structure of the comonomer used in the preparation of the microparticles by emulsion polymerization.

Optionally, the transition temperature of the microparticles may be adjusted by reacting the microparticles with a betainization reagent to convert a portion of the amine groups of the structural units derived from the comonomer to betaine groups.

It has been found that the transition temperature for microparticles having structural units derived from N,N′-dimethyl(methacryloylethyl)ammonium propane sulfonate (DMAPS), 2-(diethylamino)ethyl methacrylate (DEAEMA) comonomer, and ethylene glycol dimethacrylate (EGDMA) crosslinker, increases with increasing mol % of units derived from DMAPS. Thus, when the ratio of DMAPS to DEAEMA was varied to give microparticles with 15, 25 and 33 mol % of structural units derived from DMAPS 0.005 mol % of structural units derived from EGDMA, the remainder of the structural units being derived from DEAEMA, the transition temperatures at which the microparticles solvate, expand, and aggregate were found to be about 30, 45 and 60° C. respectively when dispersed in nanopure water.

Without wishing to be bound by any theory, the transition temperature of the microparticles increases with increasing salinity of the aqueous fluid in which the microparticles are dispersed. The person skilled in the art will understand that the injected dispersion of the microparticles in the aqueous fluid may mix with the formation water contained within the pore space of the thief zone such that the transition temperature of the microparticles may be dependent upon both the salinity of the aqueous fluid of the dispersion and the salinity of the formation water. The target amount of structural units derived from the monomer with the betaine group in the copolymer chains may therefore be varied depending on the salinity to which the microparticles are exposed within the thief zone. The salinity to which the microparticles are exposed in the thief zone may be estimated by modeling dispersive mixing of the injected dispersion with the formation water, for example, using a reservoir simulator such as STARS™.

It has also been found that the transition temperature of the microparticles increases with increasing carbon chain length of the alkylene group that links the ammonium or phosphonium cationic group and the anionic group of the betaine monomers used in preparation of the microparticles by emulsion polymerization. Typically, there is at least a 5° C. increase in the transition temperature at which the microparticles begin to expand in size with each additional carbon atom in the alkylene linker group of the betaine groups of the structural units derived from the betaine monomer.

In embodiments, a dispersion of this disclosure is injected into a thief zone of a reservoir in an amount that is suitable for reducing the permeability of a thief zone to water. The skilled person could determine a suitable amount which will be dependent upon the pore volume of the thief zone. As the skilled person will appreciate, the amount of the dispersion that is required may also be dependent on the concentration (weight percent) of the microparticles dispersed in the aqueous fluid. Thus, the required pore volume of the dispersion will decrease with increasing concentration of the microparticles dispersed in the aqueous fluid.

Suitably, the dispersion comprising the herein-disclosed polymeric microparticles dispersed in an aqueous fluid is injected into the reservoir in a pore volume amount in the range of from 0.05 to 1, from 0.2 to 0.5, or about 0.3 PV.

The term “pore volume” is used herein to mean the “effective pore volume” between an injection well and a production well. The “effective pore volume” is the interconnected pore volume or void space in a rock that contributes to fluid flow or permeability in a reservoir. Effective pore volume excludes isolated pores and pore volume occupied by water adsorbed on clay minerals or other grains. Effective pore volume may be determined using techniques well known to the person skilled in the art such as from reservoir modeling or reservoir engineering calculations.

In embodiments, the dispersion of microparticles in the aqueous fluid comprises from 0.01 to 10% by weight, from 0.02 to 5% by weight, or from 0.05 to 1% by weight of microparticles based on the total weight of the dispersion.

According to the process of embodiments of this disclosure, the dispersion is injected down an injection well (or alternatively a production well that has been taken off production) and into a thief zone so as to reduce the permeability of the thief zone to water. Initial expansion and aggregation of the microparticles may occur in a single location in a thief zone or at a plurality of locations. For instance, different forms or grades of microparticles may be present in a single dispersion according to embodiments of this disclosure. These different grades of microparticles may undergo expansion and aggregation at different transition temperatures. In turn, expansion and aggregation of the different grades of microparticles may occur in the thief zone at different locations having different temperatures, thereby reducing the permeability of the thief zone to water at a plurality of locations. In an embodiment, the herein-disclosed dispersion may be used to reduce the permeability of a plurality of thief zones.

The well into which the herein-disclosed dispersion is injected may be an injection well or a production well that penetrates at least one thief zone and at least one hydrocarbon-bearing zone of the petroleum reservoir. Where the herein-disclosed dispersion is injected into a production well, the well is taken off production prior to injection of the composition.

The transition temperature of the microparticles of the dispersion should be greater than the maximum temperature encountered in the well (excluding a thief zone) into which the dispersion of the microparticles is injected. It will be understood that by using microparticles having a transition temperature which is greater than the maximum temperature encountered in the well, expansion and aggregation of the microparticles before they enter the thief zone can be avoided. The maximum temperature encountered in a particular well (excluding a thief zone) may be readily determined by the skilled person.

The transition temperature of the microparticles should also be at or below the maximum temperature encountered in the thief zone such that the microparticles expand and aggregate within the thief zone of the reservoir. The person skilled in the art will understand that the temperature of the thief zone of the reservoir may vary with increasing radial distance from the well into which the dispersion comprising the temperature sensitive microparticles is injected. For example, in reservoirs where a waterflood has already taken place, the previously injected water typically has a temperature significantly below the original temperature of the reservoir and therefore injection of the water results in a temperature gradient across the reservoir, i.e., the injection of cold water has a cooling effect in the vicinity of the injection well and for some distance beyond it. Thus, typically, there is a temperature front in various layers of the reservoir at a radial distance from the injection well with the temperature front advancing through the layers of the reservoir over time. Thus, although the original temperature of the reservoir may be in the range of 80 to 140° C., substantial cooling of the layers of the reservoir, and hence the thief zone or zones, may have occurred during a waterflood. Typically, the temperature of the reservoir in the cooled region of the thief zone or zones (behind the temperature front) may be in the range of from 25 to 120° C., from 25 to 80° C., or from 25 to 60° C. Generally, the temperature in the cooled region of the thief zone or zones is 10 to 60° C. below, for example, 20 to 50° C. below the original reservoir temperature. Accordingly, the temperature at which expansion and aggregation of the dispersed microparticles is induced (i.e., the transition temperature) may be significantly less than the original reservoir temperature prior to waterflooding. The person skilled in the art will understand that the extent of any cooling of the thief zone in the near wellbore region of a production well is likely to be less than the extent of any cooling of the thief zone in the near wellbore region of an injection well. In embodiments, the transition temperature of the microparticles is at or slightly below (e.g. less than 30° C. below, less than 20° C. below, or less than 10° C. below) the maximum temperature encountered in the thief zone, so that the microparticles expand only after they have propagated deep into the thief zone.

The transition temperature of the microparticles of the dispersion employed in the process of the present disclosure may be readily determined by the person skilled in the art. As discussed above, the transition temperature may be adjusted by appropriate selection of the amount of monomer with the betaine group used to prepare the microparticles, the composition of the monomer with the betaine group, the composition of the water insoluble comonomer, and the % target betainization of any units derived from a comonomer having an amine group. Accordingly, dispersions of microparticles may be prepared which have an appropriate transition temperature for the temperatures encountered within the thief zone where it is desired to form a block, or multiple blocks of expanded and aggregated microparticles.

Once expansion and aggregation of the microparticles is triggered, it is believed that the aggregated microparticles block the pore throats of the thief zone and the flow of subsequently injected water is largely diverted into neighboring, previously unswept zones of the reservoir. After a period of time, the subsequently injected water flowing through neighboring zones of the reservoir acts to cool the blocked region of the thief zone to below the transition temperature resulting in de-aggregation of the aggregates and contraction of the expanded microparticles such that the contracted microparticles become redispersed in water. The resulting microparticle dispersion then flows on through the thief zone before forming a subsequent block once a further region of the thief zone having a temperature at or above the transition temperature is reached. In this way, the present disclosure allows for the formation of multiple, successive blocks within a thief zone such that a greater volume of the reservoir may be swept by subsequently injected water. The net result is that more water passes through the previously unswept zones, with more oil being swept towards the production well, i.e. sweep efficiency is improved.

Where the dispersion is injected from a production well into a thief zone or zones, if necessary, ambient temperature water (for example, seawater, estuarine water, river water, lake water or desalinated water having a temperature of about 3 to 15° C.), may be injected into the thief zone ahead of the herein-disclosed composition in order to cool the production well and thief zone thereby mitigating the risk of premature expansion and aggregation of the microparticles in the production well or in the near wellbore region of the thief zone (close to the production well).

The thief zone of the reservoir may be a layer of reservoir rock having a permeability greater than the permeability of adjacent hydrocarbon-bearing layers of the reservoir, for example, at least 50% greater. For example, the by-passed adjacent hydrocarbon-bearing layers of the reservoir may have a permeability, for example, in the range of 30 to 100 millidarcies while the thief layer may have a permeability, for example, in the range of 90 to less than 6,000 millidarcies, or 90 to 1,000 millidarcies, with the proviso that the thief layer has a permeability at least 3 times greater, or at least 4 times greater than that of the adjacent by-passed layers of the reservoir.

Alternatively, the thief zone of the reservoir may be a layer of reservoir rock having fractures therein that may be up to several hundreds of meters in length. Depending on the temperature of the surrounding rock and on the length of the fracture, the dispersion of the microparticles may penetrate a significant distance into a fracture, for example, to the fracture tip, before encountering the threshold temperature at which the microparticles expand and block the fracture.

Suitably, the microparticles are dispersed in an aqueous fluid having a total dissolved solids (TDS) content in the range of from 200 to 50,000 mg/L, in the range of from 500 to 17,500 mg/L, or in the range of from 1500 to 10,000 mg/L. The multivalent cation content of the aqueous fluid may be up to 50 mol % (based on the total moles of inorganic cations).

In at least some examples of the process for modifying the permeability to water of a thief zone, the composition comprises a dispersion of the microparticles in seawater, estuarine water, brackish water, lake water, river water, desalinated water, produced water, aquifer water or mixtures thereof, in particular, seawater. By “produced water” is meant water produced in the process of recovering hydrocarbons from the reservoir or in any other process.

Optionally, the composition employed in the method according to embodiments of this disclosure may further comprise one or more conventional additives used in enhanced oil recovery, such as viscosifiers, polymers and/or pH adjusters.

Owing to the difference in permeability between thief zones and adjacent hydrocarbon fluid-bearing zones of the reservoir, in the herein-disclosed process, most of the injected composition of this disclosure enters the thief zone. However, if desired, the hydrocarbon fluid-bearing zones of the reservoir may be isolated from the well, for example, packers may be arranged in the well, above and below a thief zone, in order to mitigate the risk of the injected dispersion entering adjacent hydrocarbon fluid-bearing zones of the reservoir.

In at least some examples of this disclosure, the herein-disclosed composition is injected continuously or intermittently into the reservoir for up to 4 weeks, for example for 5 to 15 days.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Comparative Example A: Direct Synthesis of Poly(N,N′-Dimethyl (Methacryloylethyl) Ammonium Propane Sulfonate) (PDMAPS) Microparticles by Inverse Emulsion Polymerization

Polyoxyethylene sorbitan monooleate (Tween 80) surfactant (1.7 g, 2 wt. % based on the total weight of the emulsion), N,N′-dimethyl(methacryloylethyl)ammonium propane sulfonate (DMAPS) monomer (1.9 g), poly(ethylene glycol) dimethacrylate (PEGDMA) cross-linking monomer having a number average molecular weight (Mₙ) of 550 Da (0.1 g, 5 wt. % of the total weight of DMAPS and PEGDMA monomers) and radical initiator 4,4′-azobis(4-cyanovaleric acid) (ACVA) (0.02 g, 1 wt. % of the total weight of DMAPS and PEGDMA monomers) were dissolved by stirring in water (6 mL) having a resistivity of 18.2 MΩ-cm. Toluene (80 mL) was added to the resulting aqueous solution and the mixture was sonicated in an ice bath for 10 minutes. The resulting emulsion was purged with nitrogen for 30 minutes and then heated in an oil bath with stirring (750 rpm) at a temperature of 65° C. for 16 hours.

The resulting polymeric microparticles were found to be ill-defined with a broad size distribution as determined by dynamic light scattering (DLS) and scanning electron microscopy (SEM) analyses. The microparticle diameters were found to be in the range of 70 to 160 nm by SEM. This comparative example shows that microparticles comprising crosslinked homopolymer chains having units derived from DMAPS and PEGDMA monomers do not have the desired well defined particle size for use in the method of this disclosure.

### Comparative Example B: Direct Synthesis of N,N′-dimethyl(methacryloylethyl) Ammonium Propane Sulfonate (DMAPS) and N-isopropylacrylamide (NiPAM) Copolymer Microparticles

Microparticles comprising copolymers of N,N′-dimethyl(methacryloylethyl) ammonium propane sulfonate (DMAPS) and N-isopropylacrylamide (NiPAM) were prepared using different weight ratios of DMAPS and NiPAM.

### (a) 1:5 Ratio of DMAPS to NiPAM

Sodium dodecyl sulfate (SDS) surfactant (0.04 g, 2 wt. % based on the weight of DMAPS and NiPAM), N,N′-dimethyl(methacryloylethyl)ammonium propane sulfonate (DMAPS) monomer (0.2 g), N-isopropylacrylamide (NiPAM) monomer (1.8 g), N,N′-methylenebisacrylamide (MBAc) cross-linking monomer (0.04 g, 2 wt. % based on the weight of DMAPS and NiPAM) and the radical initiator potassium persulfate (KPS) (0.02 g, 1 wt. % of DMAPS and NiPAM) were dispersed in water (98 mL) having a resistivity of 18.2 MΩ-cm by stirring (in the order listed). The mixture was purged with nitrogen for 30 minutes with stirring and then heated in an oil bath with stirring (magnetic stirrer with oval shaped bar, 600 rpm) at 65° C. for 7 hours. The resulting well-defined microparticles were obtained as a dispersion in water. The hydrodynamic diameter (Dₕ) of the microparticles was determined by dynamic light scattering and found to be 130 nm with a dispersity of 0.13 at 25° C. However, variable temperature DLS analysis of these PDMAPS-co-PNiPAM microparticles showed that microparticle size (hydrodynamic diameter) decreased with increasing temperature due to the lower critical solution temperature behavior of PNiPAM units and the microparticles are therefore not suitable for use in the method of this disclosure.

### (b) 1:1 Ratio of DMAPS to NiPAM

SDS surfactant (0.04 g, 2 wt. % based on the weight of DMAPS and NiPAM), DMAPS (1.0 g), NiPAM (1.0 g), MBAc (0.04 g, 2 wt. % based on the weight of DMAPS and NiPAM) and the radical initiator potassium persulfate (KPS) (0.02 g, 1 wt. % of DMAPS and NiPAM) were dispersed in water (98 mL) having a resistivity of 18.2 MΩ-cm by stirring (in the order listed). The mixture was purged with nitrogen for 30 minutes with stirring and then heated in an oil bath with stirring (magnetic stirrer with oval shaped bar, 600 rpm) at 65° C. for 7 hours. The resulting polymeric microparticles were significantly aggregated and found to be ill-defined with a broad size distribution as determined by dynamic light scattering (DLS).

These comparative examples show that microparticles comprised of PDMAPS-co-PNiPAM chains do not have the desired properties for use in the method of this disclosure.

### Direct Syntheses of Microparticles Using Sulfobetaine Monomers

### Example 1: Direct Synthesis of N,N′-Dimethyl(Methacryloylethyl) Ammonium Propane Sulfonate (DMAPS) and 2-(Diethylamino)ethyl Methacrylate (DEAEMA) Copolymer Microparticles Using Varying Ratios of DMAPS to DEAEMA

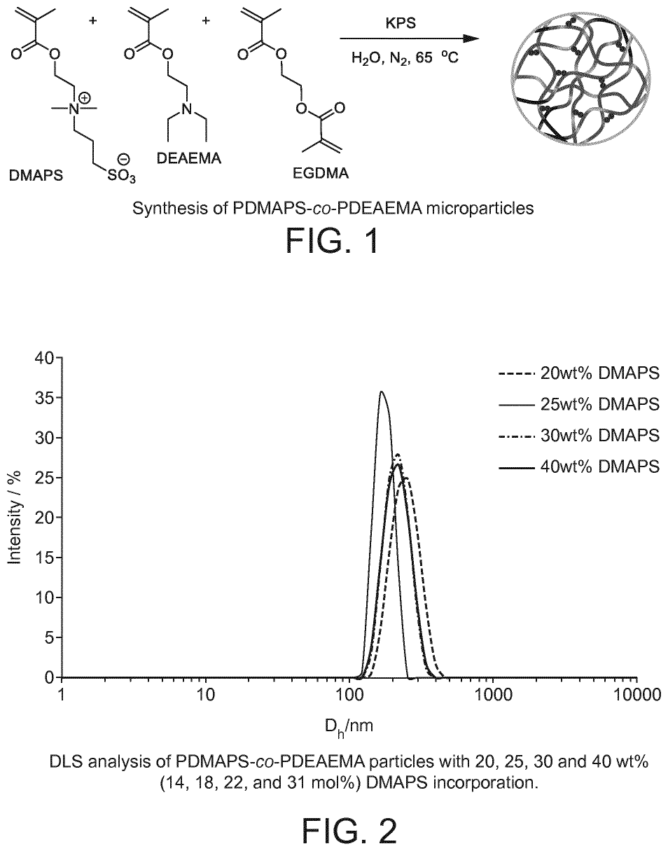

FIG. 1 is a schematic of the synthesis of PDMAPS-co-PDEAEMA microparticles comprising crosslinked copolymer chains having structural units derived from (N,N′-dimethyl(methacryloylethyl)ammonium propane sulfonate (DMAPS) monomer, 2-(diethylamino)ethyl methacrylate (DEAEMA) monomer and ethylene glycol dimethacrylate (EGDMA) crosslinking monomer.

### (a) 18 mol % (25 wt %) DMAPS

N,N′-Dimethyl(methacryloylethyl)ammonium propane sulfonate (DMAPS) monomer (0.63 g), 2-(diethylamino)ethyl methacrylate (DEAEMA) monomer (1.87 g) and ethylene glycol dimethacrylate (EGDMA) cross-linking monomer (0.025 g, 1 wt. % based on the weight of DMAPS and DEAEMA) were dispersed in deionized water (47 mL) with stirring (in the order listed). The resulting mixture was purged with nitrogen for 20 minutes with stirring and then heated for 5 minutes in an oil bath at a temperature of 65° C. with stirring. The DEAEMA monomer is water immiscible and the mixture initially comprised two separate phases (a water phase and an oil phase comprising DEAEMA monomer. However, stirring of the mixture resulted in the formation of an opaque emulsion comprising droplets of DEAEMA monomer dispersed in a continuous aqueous phase (hereinafter referred to as “an oil-in-water emulsion”). Thus, the DMAPS monomer acted as a surfactant thereby aiding emulsification of the mixture. The radical initiator potassium persulfate (KPS) (0.025 g, 1 wt. % of DMAPS and DEAEMA) was dissolved separately in deionized water (1 mL) and the resulting solution was purged for 5 minutes with nitrogen. The degassed KPS solution was then added to the degassed monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 170 nm with a dispersity of 0.03.

### (b) 14 mol % (20 wt %) DMAPS

N,N′-Dimethyl(methacryloylethyl)ammonium propane sulfonate (DMAPS) monomer (0.5 g), 2-(diethylamino)ethyl methacrylate (DEAEMA) monomer (2.0 g) and ethylene glycol dimethacrylate (EGDMA) cross-linking monomer (0.025 g, 1 wt. % based on the weight of DMAPS and DEAEMA) were dispersed in deionized water (47 mL) with stirring (in the order listed) thereby forming an oil-in-water emulsion. The resulting mixture was purged with nitrogen for 20 minutes with stirring and then heated for 5 minutes in an oil bath at a temperature of 65° C. with stirring. The radical initiator potassium persulfate (KPS) (0.025 g, 1 wt. % of DMAPS and DEAEMA) was dissolved separately in deionized water (1 mL) and the resulting solution was purged for 5 minutes with nitrogen. The degassed KPS solution was then added to the degassed monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 230 nm with a dispersity of 0.10.

### (c) 22 mol % (30 wt %) DMAPS

N,N′-Dimethyl(methacryloylethyl)ammonium propane sulfonate (DMAPS) monomer (0.75 g), 2-(diethylamino)ethyl methacrylate (DEAEMA) monomer (1.75 g) and ethylene glycol dimethacrylate (EGDMA) cross-linking monomer (0.025 g, 1 wt. % based on the weight of DMAPS and DEAEMA) were dispersed in deionized water (47 mL) with stirring (in the order listed) thereby forming an oil-in-water emulsion. The resulting mixture was purged with nitrogen for 20 minutes with stirring and then heated for 5 minutes in an oil bath at a temperature of 65° C. with stirring. The radical initiator potassium persulfate (KPS) (0.025 g, 1 wt. % of DMAPS and DEAEMA) was dissolved separately in deionized water (1 mL) and the resulting solution was purged for 5 minutes with nitrogen. The degassed KPS solution was then added to the degassed monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 210 nm with a dispersity of 0.05.

### (d) 31 mol % (40 wt %) DMAPS

N,N′-Dimethyl(methacryloylethyl)ammonium propane sulfonate (DMAPS) monomer (1.0 g), 2-(diethylamino)ethyl methacrylate (DEAEMA) monomer (1.5 g) and ethylene glycol dimethacrylate (EGDMA) cross-linking monomer (0.025 g, 1 wt. % based on the weight of DMAPS and DEAEMA) were dispersed in deionized water (47 mL) with stirring (in the order listed) thereby forming an oil-in-water emulsion. The resulting mixture was purged with nitrogen for 20 minutes with stirring and then heated for 5 minutes in an oil bath at a temperature of 65° C. with stirring. The radical initiator potassium persulfate (KPS) (0.025 g, 1 wt. % of DMAPS and DEAEMA) was dissolved separately in deionized water (1 mL) and the resulting solution was purged for 5 minutes with nitrogen. The degassed KPS solution was then added to the degassed monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 210 nm with a dispersity of 0.09.

### Dynamic Light Scattering Temperature Experiments

Dynamic light scattering (DLS) experiments were performed to determine how the particle size (Dₕ) of the poly(N,N′-dimethyl(methacryloylethyl)ammonium propane sulfonate) (PDMAPS) and poly(2-(diethylamino)ethyl methacrylate) (PDEAEMA) copolymer particles varied with temperature. DLS experiments were performed using a Malvern Zetasizer NanoS instrument with a 4 mW He—Ne 633 nm laser module and the data was analyzed using Malvern DTS v7.3.0 software. The microparticle dispersions were analyzed at a concentration of 1 mg/mL (in a quartz cuvette). Data was collected at temperature intervals of 5° C. over a temperature range of 10° C. to 90° C. and the microparticle dispersion was allowed to equilibrate for at least five minutes at each temperature. At least 3 measurements were made at each temperature and data was reported as an average of these measurements.

FIG. 2 shows the results of the DLS analyses (intensity in percent (%) as a function of hydrodynamic diameter (Dₕ) in nanometers (nm)) of PDMAPS-co-PDEAEMA crosslinked microparticles with 20, 25, 30 and 40 wt % (14, 18, 22, 31 mol %) DMAPS incorporation.

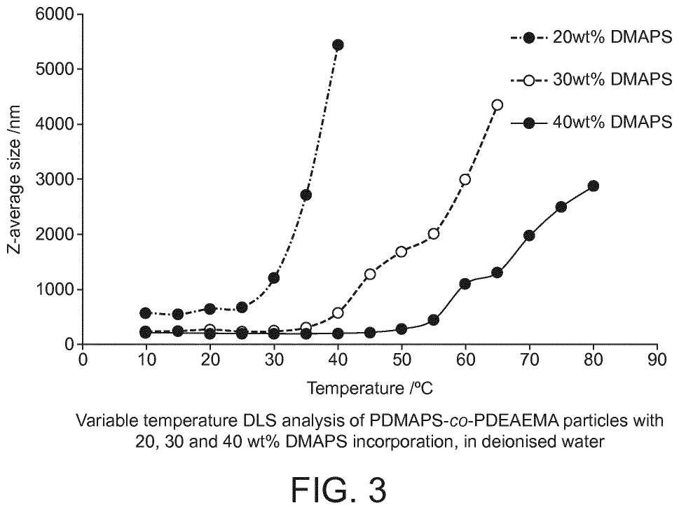

FIG. 3 is a plot of average hydrodynamic diameter (Z) (nm) as a function of temperature (° C.) for the DLS analysis of PDMAPS-co-PDEAEMA microparticles, when the microparticles are dispersed in deionized water. The results presented in FIG. 3 are for microparticles with 20%, 30% and 40 wt % of units derived from DMAPS monomer (corresponding to 14, 22 and 31 mol % of units derived from DMAPS monomer). From FIG. 3, it can be seen that the transition temperature increases with the incorporation of an increasing wt % of units derived from DMAPS monomer

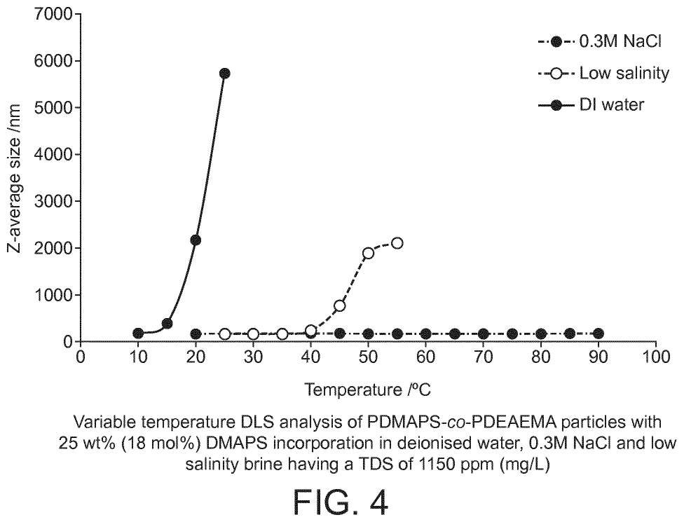

FIG. 4 shows how the average hydrodynamic diameter (Z) of the microparticles change with temperature when dispersed in 0.3M sodium chloride solution and in a low salinity brine having a TDS of 1150 ppm (mg/L) relative to dispersion thereof in solely deionized water. (The low salinity brine comprised a 30 fold dilution of a synthetic North Sea brine). The results presented in FIG. 4 are for microparticles with 25 wt % (18 mol %) of structural units derived from DMAPS. The microparticles were found to exhibit a temperature transition in the low salinity brine (beginning at about 40° C.) but not in the 0.3 M sodium chloride solution (although it is possible that the temperature transition may be higher than 90° C. in such higher salinity fluids).

### Example 2—Direct Synthesis of N,N′-Dimethyl(methacryloylethyl)ammonium butane sulfonate and 2-(Diethylamino)ethyl Methacrylate) (DEAEMA) Copolymer Microparticles

N,N′-Dimethyl(methacryloylethyl)ammonium butane sulfonate monomer (0.63 g), 2-(diethylamino)ethyl methacrylate (DEAEMA) monomer (1.87 g) and ethylene glycol dimethacrylate (EGDMA) cross-linking monomer (0.025 g, 1 wt. % based on the weight of betaine monomer and DEAEMA) were dispersed in deionized water (47 mL) with stirring (in the order listed) thereby forming an oil-in-water emulsion. The resulting mixture was purged with nitrogen for 20 minutes with stirring and then heated for 5 minutes in an oil bath at a temperature of 65° C. with stirring. The radical initiator potassium persulfate (KPS) (0.025 g, 1 wt. % of betaine monomer and DEAEMA) was dissolved separately in deionized water (1 mL) and the resulting solution was purged for 5 minutes with nitrogen. The degassed KPS solution was then added to the degassed monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 170 nm with a dispersity of 0.05.

### Example 3: Direct Synthesis of N,N′-Diethyl(methacryloylethyl)ammonium propane sulfonate and 2-(Diethylamino)ethyl Methacrylate) (DEAEMA) Copolymer Microparticles

N,N′-Diethyl(methacryloylethyl)ammonium propane sulfonate monomer (0.63 g), 2-(diethylamino)ethyl methacrylate (DEAEMA) monomer (1.87 g) and ethylene glycol dimethacrylate (EGDMA) cross-linking monomer (0.025 g, 1 wt. % based on the weight of betaine monomer and DEAEMA) were dispersed in deionized water (47 mL) with stirring (in the order listed) thereby forming an oil-in-water emulsion. The resulting mixture was purged with nitrogen for 20 minutes with stirring and then heated for 5 minutes in an oil bath at a temperature of 65° C. with stirring. The radical initiator potassium persulfate (KPS) (0.025 g, 1 wt. % of betaine monomer and DEAEMA) was dissolved separately in deionized water (1 mL) and the resulting solution was purged for 5 minutes with nitrogen. The degassed KPS solution was then added to the degassed monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 250 nm with a dispersity of 0.08.

### Example 4: Direct Synthesis of N,N′-Dimethyl(methacrylamide propyl)ammonium propane sulfonate and 2-(Diethylamino)ethyl Methacrylate) (DEAEMA) Copolymer Microparticles

N,N′-Dimethyl(methacrylamide propyl)ammonium propane sulfonate monomer (0.63 g), 2-(diethylamino)ethyl methacrylate (DEAEMA) monomer (1.87 g) and ethylene glycol dimethacrylate (EGDMA) cross-linking monomer (0.025 g, 1 wt. % based on the weight of betaine monomer and DEAEMA) were dispersed in deionized water (47 mL) with stirring (in the order listed) thereby forming an oil-in-water emulsion. The resulting mixture was purged with nitrogen for 20 minutes with stirring and then heated for 5 minutes in an oil bath at a temperature of 65° C. with stirring. The radical initiator potassium persulfate (KPS) (0.025 g, 1 wt. % of betaine monomer and DEAEMA) was dissolved separately in deionized water (1 mL) and the resulting solution was purged for 5 minutes with nitrogen. The degassed KPS solution was then added to the degassed monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 280 nm with a dispersity of 0.09.

### Example 5: Direct Synthesis of 3-(4-(2-(Methacryloyloxy)ethyl)morpholinio)propane sulfonate and 2-(Diethylamino)ethyl Methacrylate) (DEAEMA) Copolymer Microparticles

3-(4-(2-(Methacryloyloxy)ethyl)morpholinio)propane sulfonate monomer (0.63 g), 2-(diethylamino)ethyl methacrylate (DEAEMA) monomer (1.87 g) and ethylene glycol dimethacrylate (EGDMA) cross-linking monomer (0.025 g, 1 wt. % based on the weight of betaine monomer and DEAEMA) were dispersed in deionized water (47 mL) with stirring (in the order listed) thereby forming an oil-in-water emulsion. The resulting mixture was purged with nitrogen for 20 minutes with stirring and then heated for 5 minutes in an oil bath at a temperature of 65° C. with stirring. The radical initiator potassium persulfate (KPS) (0.025 g, 1 wt. % of betaine monomer and DEAEMA) was dissolved separately in deionized water (1 mL) and the resulting solution was purged for 5 minutes with nitrogen. The degassed KPS solution was then added to the degassed monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 180 nm with a dispersity of 0.11.

### Direct Synthesis of Microparticles Using Phosphobetaine Monomers

### Example 6: Direct Synthesis of Methacryloylethyl Phosphorylcholine (MPC) and 2-(Diethylamino)ethyl Methacrylate) (DEAEMA) Copolymer Microparticles

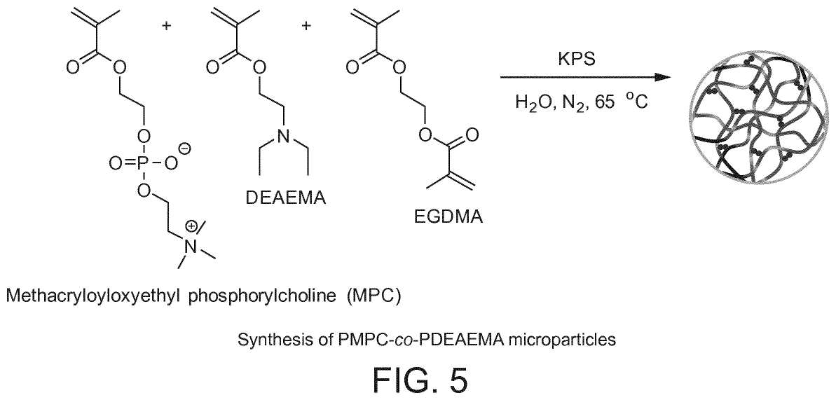

FIG. 5 is a schematic showing the synthesis of PMPC-co-PDEAEMA microparticles comprising crosslinked copolymer chains having structural units derived from methacryloylethyl phosphorylcholine (MPC) monomer, 2-(diethylamino)ethyl methacrylate (DEAEMA) monomer and ethylene glycol dimethacrylate (EGDMA) crosslinking monomer.

2-Methacryloyloxyethyl phosphorylcholine (MPC) monomer (0.63 g), 2-(diethylamino)ethyl methacrylate (DEAEMA) monomer (1.87 g, 17 mol %, 25 wt % of MPC and DEAEMA) and ethylene glycol dimethacrylate (EGDMA) cross-linking monomer (0.025 g, 1 wt. % based on the weight of MPC and DEAEMA) were dispersed in deionized water (47 mL) with stirring (in the order listed) thereby forming an oil-in-water emulsion. The resulting mixture was purged with nitrogen for 20 minutes with stirring and then heated for 5 minutes in an oil bath at a temperature of 65° C. with stirring. The radical initiator potassium persulfate (KPS) (0.025 g, 1 wt. % of MPC and DEAEMA) was dissolved separately in deionized water (1 mL) and the resulting solution was purged for 5 minutes with nitrogen. The degassed KPS solution was then added to the degassed monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water.

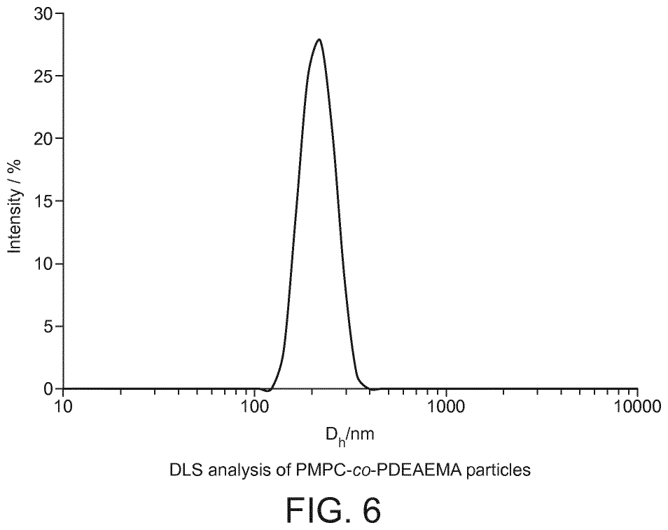

FIG. 6 shows the results of the DLS analyses (intensity in percent (%) as a function of hydrodynamic diameter (Dₕ) in nanometers (nm)) of PMPC-co-PDEAEMA crosslinked microparticles with 17 mol % (25 wt %) MPC incorporation. The hydrodynamic diameter (Dₕ) of the microparticles was determined by dynamic light scattering and found to be 250 nm with a dispersity of 0.07.

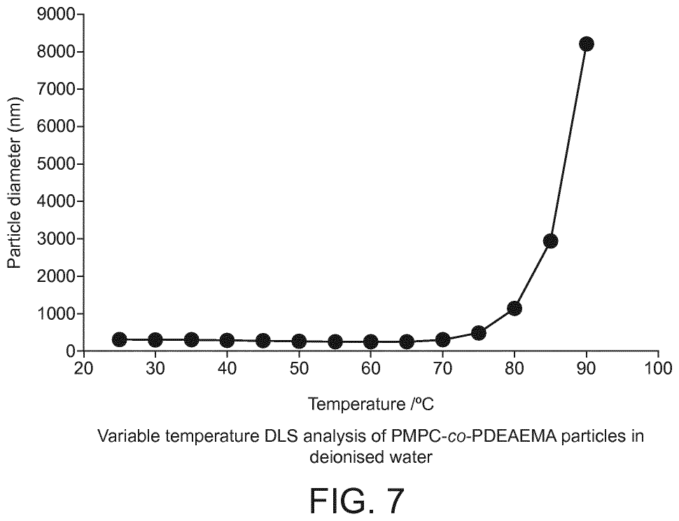

FIG. 7 is a plot of average hydrodynamic particle diameter (Z) (nm) as a function of temperature (° C.) for the variable temperature DLS analysis of PMPC-co-PDEAEMA microparticles dispersed in deionized water. The results presented in FIG. 7 are for microparticles with 17 mol % (25 wt %) of units derived from MPC monomer. FIG. 7 thus shows how the diameter of PMPC-co-PDEAEMA crosslinked microparticles changes with changing temperature when the microparticles are dispersed in deionized water.

### Direct Synthesis of Microparticles Using Sulfabetaine Monomers

### Example 7: Direct Synthesis of N,N′-Dimethyl(methacryloylethyl)ammonium propane sulfate and 2-(Diethylamino)ethyl Methacrylate) (DEAEMA) Copolymer Microparticles

N,N′-Dimethyl(methacryloylethyl)ammonium propane sulfate monomer (0.63 g), 2-(diethylamino)ethyl methacrylate (DEAEMA) monomer (1.87 g) and ethylene glycol dimethacrylate (EGDMA) cross-linking monomer (0.025 g, 1 wt. % based on the weight of betaine monomer and DEAEMA) were dispersed in deionized water (47 mL) with stirring (in the order listed) thereby forming an oil-in-water emulsion. The resulting mixture was purged with nitrogen for 20 minutes with stirring and then heated for 5 minutes in an oil bath at a temperature of 65° C. with stirring. The radical initiator potassium persulfate (KPS) (0.025 g, 1 wt. % of betaine monomer and DEAEMA) was dissolved separately in deionized water (1 mL) and the resulting solution was purged for 5 minutes with nitrogen. The degassed KPS solution was then added to the degassed monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 260 nm with a dispersity of 0.05.

### Direct Synthesis of Microparticles Using Sulfobetaines Monomers and Different Comonomers

### Example 8: Direct Synthesis of N,N′-Dimethyl(methacryloylethyl)ammonium propane sulfonate and 2-(Diisopropylamino)ethyl Methacrylate) (DⁱPAEMA) Copolymer Microparticles

N,N′-Dimethyl(methacryloylethyl)ammonium propane sulfonate monomer (DMAPS) (0.63 g), 2-(diisopropylamino)ethyl methacrylate (DⁱPAEMA) monomer (1.87 g) and ethylene glycol dimethacrylate (EGDMA) cross-linking monomer (0.025 g, 1 wt. % based on the weight of DMAPS and DⁱPAEMA) were dispersed in deionized water (47 mL) with stirring (in the order listed) thereby forming an oil-in-water emulsion. The resulting mixture was purged with nitrogen for 20 minutes with stirring and then heated for 5 minutes in an oil bath at a temperature of 65° C. with stirring. The radical initiator potassium persulfate (KPS) (0.025 g, 1 wt. % of DMAPS and DⁱPAEMA) was dissolved separately in deionized water (1 mL) and the resulting solution was purged for 5 minutes with nitrogen. The degassed KPS solution was then added to the degassed monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 240 nm with a dispersity of 0.02.

### Example 9: Direct Synthesis of N,N′-Dimethyl(methacryloylethyl)ammonium propane sulfonate and Methyl methacrylate (MMA) Copolymer Microparticles

N,N′-Dimethyl(methacryloylethyl)ammonium propane sulfonate monomer (DMAPS) (0.63 g), methyl methacrylate (MMA) monomer (1.87 g) and ethylene glycol dimethacrylate (EGDMA) cross-linking monomer (0.025 g, 1 wt. % based on the weight of DMAPS and MMA) were dispersed in deionized water (47 mL) with stirring (in the order listed) thereby forming an oil-in-water emulsion. The resulting mixture was purged with nitrogen for 20 minutes with stirring and then heated for 5 minutes in an oil bath at a temperature of 65° C. with stirring. The radical initiator potassium persulfate (KPS) (0.025 g, 1 wt. % of DMAPS and MMA) was dissolved separately in deionized water (1 mL) and the resulting solution was purged for 5 minutes with nitrogen. The degassed KPS solution was then added to the degassed monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 12 nm with a dispersity of 0.41.

While various embodiments have been shown and described, modifications thereof can be made by one skilled in the art without departing from the spirit and teachings of the disclosure. The embodiments described herein are exemplary only, and are not intended to be limiting. Many variations and modifications of the subject matter disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L} and an upper limit, R_{U} is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural, or other details supplementary to those set forth herein.

The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Alternative embodiments that result from combining, integrating, and/or omitting features of the embodiment(s) are also within the scope of the disclosure. While compositions and methods are described in broader terms of “having”, “comprising,” “containing,” or “including” various components or steps, the compositions and methods can also “consist essentially of” or “consist of” the various components and steps. Use of the term “optionally” with respect to any element of a claim means that the element is required, or alternatively, the element is not required, both alternatives being within the scope of the claim.

Numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

Embodiments disclosed herein include:

A: Polymeric microparticles comprising crosslinked copolymer chains comprising structural units derived from: (i) a water-soluble or water-dispersible monomer comprising a betaine group, (ii) a water-insoluble monomer, and, (iii) a cross-linking monomer comprising at least two sites of ethylenic unsaturation, wherein the polymeric microparticles comprise from 10 to 40 mole percent (mol %) of units derived from the monomer comprising the betaine group, and wherein the polymeric microparticles have a transition temperature which is a temperature greater than or equal to which the microparticles expand in size.

B: A dispersion of polymeric microparticles in an aqueous fluid, wherein the polymeric microparticles comprise: crosslinked copolymer chains comprising structural units derived from (i) a water-soluble or water-dispersible monomer comprising a betaine group, (ii) a water-insoluble monomer, and, (iii) a cross-linking monomer having at least two sites of ethylenic unsaturation, wherein the polymeric microparticles comprise from 10 to 40 mole percent (mol %) of units derived from the monomer comprising the betaine group, and wherein the polymeric microparticles have a transition temperature which is a temperature greater than or equal to which the microparticles expand in size.

C: A process for recovering hydrocarbon fluids from a porous and permeable subterranean petroleum reservoir, the process comprising: (a) injecting a dispersion of polymeric microparticles in an aqueous fluid into a higher permeability zone of a reservoir from an injection well or from a production well, wherein the reservoir comprises the higher permeability zone and a lower permeability zone, wherein the higher permeability zone has a permeability above that of the lower permeability zone, wherein the higher permeability zone and the lower permeability zone are penetrated by the injection well and the production well, wherein the polymeric microparticles comprise crosslinked copolymer chains comprising structural units derived from (i) a water-soluble or water-dispersible monomer comprising a betaine group, (ii) a water-insoluble monomer, and, (iii) a cross-linking monomer comprising at least two sites of ethylenic unsaturation, wherein a mole percent (mol %) of structural units derived from the monomer comprising the betaine group lies within the range of from 10 to 40 mol % based on a total molar amount of structural units in the copolymer chains, wherein the polymeric microparticles have a transition temperature, which is a temperature greater than or equal to which the microparticles expand in size, wherein the injection well has a maximum temperature below the transition temperature and the higher permeability zone comprises a region between the injection well and the production well that has a temperature greater than or equal to the transition temperature; (b) propagating the dispersion through the higher permeability zone until the dispersion reaches the region of the higher permeability zone having the temperature at or above the transition temperature such that the polymeric microparticles expand in size thereby reducing the permeability of the higher permeability zone of the reservoir; (c) diverting subsequently injected aqueous fluid from the higher permeability zone into the lower permeability zone of the reservoir; and (d) recovering hydrocarbon fluids from said at least one production well.

D: A method for preparing the polymeric microparticles by emulsion polymerization of (i) a water-soluble or water-dispersible monomer comprising a betaine group, (ii) a water-insoluble monomer and (iii) a crosslinking monomer comprising at least two sites of ethylenic unsaturation in the presence of a radical initiator, wherein droplets of an oil phase comprising the water-insoluble monomer and crosslinking monomer are dispersed in a continuous aqueous phase comprising a solution or dispersion of the water-soluble or water-dispersible monomer comprising the betaine group which acts as a reactive stabilizer for the emulsion droplets, and wherein the mole percent (mol %) of the monomer with the betaine group is from 10 to 40 mol % based on the total moles of monomer.

Each of embodiments A, B, C and D may have one or more of the following additional elements: Element 1: wherein the copolymer chains comprise structural units derived from a water-soluble or water-dispersible monomer with a betaine group selected from: (a) sulfobetaine vinyl monomers having the formula: CH₂═C(R)C(O)OR₂N⁺R′R″—R₃SO₃⁻ (I), wherein: R is selected from hydrogen and an alkyl group having from 1 to 3 carbon atoms, for example, methyl; R₂ and R₃ are alkylene groups, for example, C₂ to C₆ alkylene groups; R′ and R″ are independently selected from alkyl groups having from 1 to 3 carbon atoms; and (b) phosphobetaine vinyl monomers having the formula: CH₂═C(R)C(O)OR₂—OP(O)(O⁻)O—R₃NR′R″R′″ (II), wherein R, R₂, R₃, R′ and R″ are as defined above for formula I, and R′″ is selected from an alkyl group having from 1 to 3 carbon atoms, such as, methyl and ethyl, or methyl. Element 2: wherein the copolymer chains comprise structural units derived from a water-soluble or water-dispersible monomer of formula (I) or (II) selected from: N,N′-dimethyl(methacryloylethyl)ammonium propane sulfonate, N,N′-diethyl (methacryloylethyl) ammonium propane sulfonate, N,N′-dimethyl (methacryloylethyl) ammonium ethane sulfonate, N,N′-diethyl (methacryloylethyl) ammonium ethane sulfonate, methacryloyloxyethyl phosphorylcholine (MPC), methacryloyloxypropyl phosphorylcholine, or combinations thereof. Element 3: wherein the copolymer chains comprise structural units derived from a water-insoluble comonomer selected from dialkylaminoalkyl alkacrylates of general formula [H₂C═C(CH₃)CO₂R₄NR⁵R⁶] (III) and dialkylaminoalkyl alkacrylamides of general formula [H₂C═C(CH₃)CONHR₄NR⁵R⁶] (IV), wherein R₄ is a straight chain alkylene moiety having from 1 to 5 carbon atoms that is optionally substituted by methyl; and R⁵ and R⁶ are independently selected from methyl, ethyl, n-propyl and isopropyl. Element 4: wherein the copolymer chains comprise structural units derived from a crosslinking monomer selected from diacrylamides and methacrylamides of diamines; methacrylate esters of di, tri, and tetra hydroxy compounds; divinylbenzene, 1,3-diisopropenylbenzene; vinyl or allyl esters of di or trifunctional acids; diallylamine, triallylamine, divinyl sulfone, and diethyleneglycol diallyl ether; or combinations thereof. Element 5: wherein the polymeric microparticles reversibly expand in size at the transition temperature. Element 6: wherein the water-soluble or water-dispersible monomer comprising the betaine group comprises: (a) a sulfobetaine vinyl monomer having the formula: CH₂═C(R)C(O)OR₂N⁺R′R″—R₃SO₃⁻ (I), wherein: R is selected from hydrogen and an alkyl group having from 1 to 3 carbon atoms, for example, methyl; R₂ and R₃ are alkylene groups, for example, C₂ to C₆ alkylene groups; R′ and R″ are independently selected from alkyl groups having from 1 to 3 carbon atoms; and (b) a phosphobetaine vinyl monomer having the formula: CH₂═C(R)C(O)OR₂—OP(O)(O⁻)O—R₃NR′R″R′″ (II), wherein R, R₂, R₃, R′ and R″ are as defined above for formula I, and R′″ is selected from an alkyl group having from 1 to 3 carbon atoms, for example, selected from methyl and ethyl, or methyl.

Element 7: further comprising adjusting the transition temperature of the microparticles by adjusting the mol % of structural units in the copolymer chains that are derived from the monomer comprising the betaine group. Element 8: wherein the high permeability zone is a layer of reservoir rock having a permeability that is at least 50% greater than the permeability of the lower permeability zone of the reservoir. Element 9: wherein an initial average particle diameter of the polymeric microparticles is in the range of 0.05 to 1 μm, wherein an average particle diameter of the expanded polymeric microparticles in the range of 1 to 10 microns, wherein a ratio of a volume of the expanded polymeric microparticles to an initial volume of the unexpanded polymeric microparticles is at least 5:1, at least 10:1, or at least 20:1, or a combination thereof. Element 10: wherein the expanded polymeric microparticles form aggregates having an average particle diameter in the range of from 1000 to 10000 nm. Element 11: wherein the dispersion comprises polymeric microparticles with a transition temperature in the range of from 40 to 90° C., or from 50 to 80° C., wherein the temperature in the well into which the dispersion is injected is less than or equal to 30° C., and wherein the high permeability zone comprises a region between the injection well and the production well having a temperature above the transition temperature of the polymeric microparticles. Element 12: wherein cooling of the high permeability zone in the region between the injection well and the production well that had a temperature greater than or equal to the transition temperature to a temperature below the transition temperature results in contraction and de-aggregation of the microparticles, wherein the microparticles become redispersed in water, and wherein the resulting dispersion permeates through the region until it reaches another region where the temperature is greater than or equal to the transition temperature and the microparticles expand in size to reduce the permeability within the further region.

Element 13: wherein the water-soluble or water-dispersible monomer comprising the betaine group is selected from: (a) a sulfobetaine vinyl monomer having the formula: CH₂═C(R)C(O)OR₂N⁺R′R″—R₃SO₃⁻ (I), wherein: R is selected from hydrogen and an alkyl group having from 1 to 3 carbon atoms, for example, methyl; R₂ and R₃ are alkylene groups, for example, C₂ to C₆ alkylene groups; R′ and R″ are independently selected from alkyl groups having from 1 to 3 carbon atoms; and (b) a phosphobetaine vinyl monomer having the formula: CH₂═C(R)C(O)OR₂—OP(O)(O⁻)O—R₃NR′R″R′″ (II), wherein R, R₂, R₃, R′ and R″ are as defined above for formula I, and R′″ is selected from an alkyl group having from 1 to 3 carbon atoms, such as, methyl and ethyl, or methyl; and the water-insoluble comonomer is selected from dialkylaminoalkyl alkacrylates of general formula [H₂C═C(CH₃)CO₂R₄NR⁵R⁶] (III) and dialkylaminoalkyl alkacrylamides of general formula [H₂C═C(CH₃)CONHR₄NR⁵R⁶] (IV), wherein R₄ is a straight chain alkylene moiety having from 1 to 5 carbon atoms that is optionally substituted by methyl; and R⁵ and R⁶ are independently selected from methyl, ethyl, n-propyl and isopropyl.

While preferred embodiments of the invention have been shown and described, modifications thereof can be made by one skilled in the art without departing from the teachings of this disclosure. The embodiments described herein are exemplary only, and are not intended to be limiting. Many variations and modifications of the invention disclosed herein are possible and are within the scope of the invention.

Numerous other modifications, equivalents, and alternatives, will become apparent to those skilled in the art once the above disclosure is fully appreciated. It is intended that the following claims be interpreted to embrace all such modifications, equivalents, and alternatives where applicable. Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference. Unless expressly stated otherwise, the steps in a method claim may be performed in any order and with any suitable combination of materials and processing conditions.

1. Polymeric microparticles comprising:
crosslinked copolymer chains comprising structural units derived from:
(i) a water-soluble or water-dispersible monomer comprising a betaine group,
(ii) a water-insoluble monomer, and,
(iii) a cross-linking monomer comprising at least two sites of ethylenic unsaturation,
wherein the polymeric microparticles comprise from 10 to 40 mole percent (mol %) of units derived from the monomer comprising the betaine group, and
wherein the polymeric microparticles have a transition temperature which is a temperature greater than or equal to which expansion and aggregation of the microparticles is induced.

2. The polymeric microparticles of claim 1, wherein the copolymer chains comprise structural units derived from a water-soluble or water-dispersible monomer with a betaine group selected from:
(a) sulfobetaine vinyl monomers having the formula:
CH₂═C(R)C(O)OR₂N⁺R′R″—R₃SO₃⁻ (I),
wherein: R is selected from hydrogen and an alkyl group having from 1 to 3 carbon atoms; R₂ and R₃ are alkylene groups; R′ and R″ are independently selected from alkyl groups having from 1 to 3 carbon atoms; and
(b) phosphobetaine vinyl monomers having the formula:
CH₂═C(R)C(O)OR₂—OP(O)(O⁻)O—R₃NR′R″R′″ (II),
wherein R, R₂, R₃, R′ and R″ are as defined above for formula I, and R′″ is selected from an alkyl group having from 1 to 3 carbon atoms.

3. The polymeric microparticles of claim 2, wherein the copolymer chains comprise structural units derived from a water-soluble or water-dispersible monomer of formula (I) or (II) selected from: N,N′-dimethyl(methacryloylethyl)ammonium propane sulfonate, N,N′-diethyl (methacryloylethyl) ammonium propane sulfonate, N,N′-dimethyl (methacryloylethyl) ammonium ethane sulfonate, N,N′-diethyl (methacryloylethyl) ammonium ethane sulfonate, methacryloyloxyethyl phosphorylcholine (MPC), methacryloyloxypropyl phosphorylcholine, or combinations thereof.

4. The polymeric microparticles of claim 1, wherein the copolymer chains comprise structural units derived from a water-insoluble comonomer selected from dialkylaminoalkyl alkacrylates of general formula [H₂C═C(CH₃)CO₂R₄NR⁵R⁶] (III) and dialkylaminoalkyl alkacrylamides of general formula [H₂C═C(CH₃)CONHR₄NR⁵R⁶] (IV), wherein R₄ is a straight chain alkylene moiety having from 1 to 5 carbon atoms that is optionally substituted by methyl; and R⁵ and R⁶ are independently selected from methyl, ethyl, n-propyl and isopropyl.

5. The polymeric microparticles of claim 1, wherein the copolymer chains comprise structural units derived from a crosslinking monomer selected from diacrylamides and methacrylamides of diamines; methacrylate esters of di, tri, and tetra hydroxy compounds; divinylbenzene, 1,3-diisopropenylbenzene; vinyl or allyl esters of di or trifunctional acids; diallylamine, triallylamine, divinyl sulfone, and diethyleneglycol diallyl ether; or combinations thereof.

6. The polymeric microparticles of claim 1, wherein the polymeric microparticles reversibly expand in size at the transition temperature.

7. A dispersion of polymeric microparticles in an aqueous fluid, wherein the polymeric microparticles comprise:
crosslinked copolymer chains comprising structural units derived from:
(i) a water-soluble or water-dispersible monomer comprising a betaine group,
(ii) a water-insoluble monomer, and,
(iii) a cross-linking monomer having at least two sites of ethylenic unsaturation,
wherein the polymeric microparticles comprise from 10 to 40 mole percent (mol %) of units derived from the monomer comprising the betaine group, and
wherein the polymeric microparticles have a transition temperature which is a temperature greater than or equal to which expansion and aggregation of the microparticles is induced.

8. A process for recovering hydrocarbon fluids from a porous and permeable subterranean petroleum reservoir, the process comprising:
(a) injecting a dispersion of polymeric microparticles in an aqueous fluid into a higher permeability zone of a reservoir from an injection well or from a production well, wherein the reservoir comprises the higher permeability zone and a lower permeability zone, wherein the higher permeability zone has a permeability above that of the lower permeability zone, wherein the higher permeability zone and the lower permeability zone are penetrated by the injection well and the production well, wherein the polymeric microparticles comprise crosslinked copolymer chains comprising structural units derived from (i) a water-soluble or water-dispersible monomer comprising a betaine group, (ii) a water-insoluble monomer, and, (iii) a cross-linking monomer comprising at least two sites of ethylenic unsaturation, wherein a mole percent (mol %) of structural units derived from the monomer comprising the betaine group lies within the range of from 10 to 40 mol % based on a total molar amount of structural units in the copolymer chains, wherein the polymeric microparticles have a transition temperature, which is a temperature greater than or equal to which expansion and aggregation of the microparticles is induced, wherein the injection well, excluding the higher permeability zone, has a maximum temperature below the transition temperature, and wherein the higher permeability zone comprises a region between the injection well and the production well that has a temperature greater than or equal to the transition temperature;
(b) propagating the dispersion through the higher permeability zone until the dispersion reaches the region of the higher permeability zone having the temperature at or above the transition temperature such that the polymeric microparticles expand in size thereby reducing the permeability of the higher permeability zone of the reservoir;
(c) diverting subsequently injected aqueous fluid from the higher permeability zone into the lower permeability zone of the reservoir; and
(d) recovering hydrocarbon fluids from said at least one production well.

9. The process according of claim 8, wherein the water-soluble or water-dispersible monomer comprising the betaine group comprises:
(a) a sulfobetaine vinyl monomer having the formula:
CH₂═C(R)C(O)OR₂N⁺R′R″—R₃SO₃⁻ (I),
wherein: R is selected from hydrogen and an alkyl group having from 1 to 3 carbon atoms; R₂ and R₃ are alkylene groups; R′ and R″ are independently selected from alkyl groups having from 1 to 3 carbon atoms; and
(b) a phosphobetaine vinyl monomer having the formula:
CH₂═C(R)C(O)OR₂—OP(O)(O⁻)O—R₃NR′R″R′″ (II),
wherein R, R₂, R₃, R′ and R″ are as defined above for formula I, and R′″ is selected from an alkyl group having from 1 to 3 carbon atoms.

10. The process of claim 8 further comprising adjusting the transition temperature of the microparticles by adjusting the mol % of structural units in the copolymer chains that are derived from the monomer comprising the betaine group.

11. The process according to claim 8, wherein the high permeability zone is a layer of reservoir rock having a permeability that is at least 50% greater than the permeability of the lower permeability zone of the reservoir.

12. The process according to claim 8, wherein an initial average particle diameter of the polymeric microparticles is in the range of 0.05 to 1 μm, wherein an average particle diameter of the expanded polymeric microparticles in the range of 1 to 10 microns, wherein a ratio of a volume of the expanded polymeric microparticles to an initial volume of the unexpanded polymeric microparticles is at least 5:1, or a combination thereof.

13. The process according to claim 8, wherein the expanded polymeric microparticles form aggregates having an average particle diameter in the range of from 1000 to 10000 nm.

14. The process according to claim 8, wherein the dispersion comprises polymeric microparticles with a transition temperature in the range of from 40 to 90° C., wherein the temperature in the well into which the dispersion is injected is less than or equal to 30° C., and wherein the high permeability zone comprises a region between the injection well and the production well having a temperature above the transition temperature of the polymeric microparticles.

15. The process of claim 8, wherein cooling of the high permeability zone in the region between the injection well and the production well that had a temperature greater than or equal to the transition temperature to a temperature below the transition temperature results in contraction and de-aggregation of the microparticles, wherein the microparticles become redispersed in water, and wherein the resulting dispersion permeates through the region until it reaches another region where the temperature is greater than or equal to the transition temperature and the microparticles expand in size to reduce the permeability within the further region.

16. A method comprising:
preparing the polymeric microparticles by emulsion polymerization of a solution or dispersion comprising:
(i) a water-soluble or water-dispersible monomer comprising a betaine group,
(ii) a water-insoluble monomer and
(iii) a crosslinking monomer comprising at least two sites of ethylenic unsaturation in the presence of a radical initiator,
wherein droplets of an oil phase comprising the water-insoluble monomer and crosslinking monomer are dispersed in a continuous aqueous phase comprising the solution or dispersion of the water-soluble or water-dispersible monomer comprising the betaine group which acts as a reactive stabilizer for the emulsion droplets, and
wherein the mole percent (mol %) of the monomer with the betaine group is from 10 to 40 mol % based on the total moles of monomer.

17. The method of claim 16, wherein:
the water-soluble or water-dispersible monomer comprising the betaine group is selected from:
(a) a sulfobetaine vinyl monomer having the formula:
CH₂═C(R)C(O)OR₂N⁺R′R″—R₃SO₃⁻ (I),
wherein: R is selected from hydrogen and an alkyl group having from 1 to 3 carbon atoms; R₂ and R₃ are alkylene groups; R′ and R″ are independently selected from alkyl groups having from 1 to 3 carbon atoms; and
(b) a phosphobetaine vinyl monomer having the formula:
CH₂═C(R)C(O)OR₂—OP(O)(O⁻)O—R₃NR′R″R′″ (II),
wherein R, R₂, R₃, R′ and R″ are as defined above for formula I, and R′″ is selected from an alkyl group having from 1 to 3 carbon atoms; and
the water-insoluble comonomer is selected from dialkylaminoalkyl alkacrylates of general formula [H₂C═C(CH₃)CO₂R₄NR⁵R⁶] (III) and dialkylaminoalkyl alkacrylamides of general formula [H₂C═C(CH₃)CONHR₄NR⁵R⁶] (IV), wherein R₄ is a straight chain alkylene moiety having from 1 to 5 carbon atoms that is optionally substituted by methyl; and R⁵ and R⁶ are independently selected from methyl, ethyl, n-propyl and isopropyl.
